(19) United States
(12) Patent Application Publication
(10) Pub. No.: US 2015/0206521 A1
(43) Pub. Date: Jul. 23, 2015

(54) DEVICE, METHOD AND SYSTEM FOR MAKING MUSIC

(71) Applicant: Nexovation, Inc., Hendersonville, TN (US)

(72) Inventors: Robert J. Sexton, Hendersonville, TN (US); Matthew C. Sexton, Nashville, TN (US)

(73) Assignee: Nexovation, Inc., Hendersonville, TN (US)

(21) Appl. No.: 14/161,665

(22) Filed: Jan. 22, 2014

(51) Int. Cl. G10H 1/32; G10H 3/18; G10H 3/14; G10H 1/02

(52) U.S. Cl. CPC G10H 1/32; G10H 1/02; G10H 3/186; G10H 3/146; G10H 2210/161

(57) ABSTRACT

A music device for making music includes a first input part for generating a first signal based on a user input, a music signal generator for generating a music signal based on the first signal, a second input part for generating a second signal based on a user input, the second signal controlling the music signal generator, and the second input part including a plurality of first buttons which correspond to a range including at least one of a key, a note and a chord, and a plurality of second buttons which correspond to at least one of a note and a musical scale within the range.

### CROSS REFERENCE TO RELATED APPLICATIONS

This Application claims priority to U.S. Provisional Patent Application No. 61/511,041 which was filed on Jul. 23, 2011.

### BACKGROUND OF THE INVENTION

1. Field of the Invention

The present invention relates to a music device and, more particularly, to a music device which includes first and second input parts.

2. Description of the Related Art

Traditional music devices include string instruments, woodwind instruments, brass instruments, and keyboard instruments.

Traditional musical instruments and even electronic versions of traditional instruments have been essentially the same for hundreds of years. A high level of skill and time to learn are required to master most traditional instruments as a musician, which typically requires instruction from someone who has previously mastered that traditional instrument.

The basic construction of and methods for playing traditional musical instruments have remained virtually unchanged for hundreds of years. Different skills and dexterities have evolved in societies over the centuries and there is the opportunity to create a new class of musical instruments and musicians, adapting to the technologies, skill sets and the trends of 21st century people and future musicians.

### SUMMARY

In view of the foregoing and other problems, disadvantages, and drawbacks of the aforementioned conventional systems and methods, an exemplary aspect of the present invention is directed to a music device which may allow musicians and composers to become proficient at playing music in much less time and with fewer physical requirements than with conventional musical instruments.

An exemplary aspect of the present invention is directed to a music device for making music, including a first input part for generating a first signal based on a user input, a music signal generator for generating a music signal based on the first signal, and a second input part for generating a second signal based on a user input, the second signal controlling the music signal generator, and the second input part including a plurality of first buttons which correspond to a range including at least one of a key, a note and a chord, and a plurality of second buttons which correspond to at least one of a note and a musical scale within the range.

Another exemplary aspect of the present invention is directed to a music device for making music, including a body, a first input part formed on the body, for generating a first signal based on a user input, a music signal generator formed in the body, for generating a music signal based on the first signal, a neck connected to the body, a second input part for generating a second signal based on a user input, the second signal controlling the music signal generator, and the second input part including a plurality of first buttons which correspond to a range including at least one of a key, a note and a chord, and a plurality of second buttons which correspond to at least one of a note and a musical scale within the range, and an output part for outputting the music signal.

Another exemplary aspect of the present invention is directed to a system for making music, including a device for generating a programming signal, and a music device which is programmable by the programming signal, for making music. The music device including a first input part for generating a first signal based on a user input, a music signal generator for generating a music signal based on the first signal, and a second input part for generating a second signal based on a user input, the second signal controlling the music signal generator, and the second input part including a plurality of first buttons which correspond to a range including at least one of a key, a note and a chord, and a plurality of second buttons which correspond to at least one of a note and a musical scale within the range.

Another exemplary aspect of the present invention is directed to a method of making music. The method includes generating a first signal with a first input part based on a user input, generating a music signal with a music signal generator based on the first signal and generating a second signal with a second input part based on a user input, the second signal controlling the music signal generator, and the second input part including a plurality of first buttons which correspond to a range including at least one of a key, a note and a chord, and a plurality of second buttons which correspond to at least one of a note and a musical scale within the range.

With its unique and novel features, the present invention provides a music device which may allow musicians and composers greater variation of musical or tonal parameters and allow them to become proficient at playing music in much less time than with conventional musical instruments.

### BRIEF DESCRIPTION OF THE DRAWINGS

The foregoing and other objects, aspects and advantages will be better understood from the following detailed description of the embodiments of the invention with reference to the drawings, in which:

FIG. 1A illustrates a music device 100, according to an exemplary aspect of the present invention;

FIG. 1B illustrates a first input part 160a, according to an exemplary aspect of the present invention;

FIG. 1C illustrates a first input part 160b, according to an exemplary aspect of the present invention;

FIG. 1D illustrates an exemplary connection between first input part 160 and receiving part 150a, according to an exemplary aspect of the present invention;

FIG. 1E illustrates a music device 100 including string instrument input module 160c connected to receiving part 150b, and neck 175 connected to receiving part 150c, according to an exemplary aspect of the present invention;

FIG. 1F illustrates an exemplary connection between string instrument input module 160c and receiving part 150b, according to an exemplary aspect of the present invention;

FIG. 1G illustrates a music device 100 including keyboard instrument input module 160d, according to an exemplary aspect of the present invention;

FIG. 1H illustrates a bottom surface 111a of the body 110, and bottom surface 111b of the neck 175 in the music device 100, according to an exemplary aspect of the present invention;

FIG. 1I illustrates a connector 191 between the body 110 and neck 175, according to an exemplary aspect of the present invention;

FIG. 1J illustrates a music device 100 including a neck 175 with a plurality of first buttons 135 and a plurality of second buttons 138 which are formed in a lateral direction (e.g., substantially perpendicular to a longitudinal direction of the neck 175) from the plurality of first buttons 135, according to an exemplary aspect of the present invention;

FIG. 1K illustrates a music device 100 including a percussion instrument input module 160e connected to the receiving part 150b, according to an exemplary aspect of the present invention;

FIG. 2A-2E illustrates the music device 100 having various configurations, according to an exemplary aspect of the present invention;

FIG. 3A illustrates a system 300 including the music device 350, according to an exemplary aspect of the present invention;

FIG. 3B illustrates a circuit 365 in the music device 100, according to an exemplary aspect of the present invention;

FIG. 4 illustrates method 400 of making music, according to an exemplary aspect of the present invention;

FIG. 5 illustrates an exemplary hardware configuration of a system 500, according to an exemplary aspect of the present invention;

FIG. 6 illustrates an exemplary recording medium 600 and an exemplary recording medium 602, according to an exemplary aspect of the present invention;

FIGS. 7A-7F are top views respectively of a finger 701, bow 702, wind 703 instrument versions, pedal 704, alternative neck 705, and a side view of bow 706, according to another exemplary aspect of the present invention;

FIGS. 8A-8H are top views respectively of a finger instrument 701, according to an exemplary aspect of the present invention;

FIG. 9 is a bottom view of the finger instrument 701, according to an exemplary aspect of the present invention;

FIG. 10 is a side view of the finger instrument of 701, according to an exemplary aspect of the present invention;

FIG. 11 is another side view of the finger instrument 701, according to an exemplary aspect of the present invention;

FIGS. 12A-12G are a top view of a bow instrument 702, according to an exemplary aspect of the present invention;

FIG. 13 is a bottom view of a bow instrument 702, according to an exemplary aspect of the present invention;

FIG. 14 is a side view of the bow instrument 702, according to an exemplary aspect of the present invention;

FIG. 15 is another side view of the bow instrument 702, according to an exemplary aspect of the present invention;

FIG. 16 is a side view of a bow 1601 for use with bow instrument 702, according to an exemplary aspect of the present invention;

FIGS. 17A-17D are a top view for a wind instrument 703, according to an exemplary aspect of the present invention;

FIG. 18 is a bottom view of the wind instrument 703, according to an exemplary aspect of the present invention;

FIG. 19 is a side view of the wind instrument 703, according to an exemplary aspect of the present invention;

FIG. 20 is another side view of the wind instrument 703, according to an exemplary aspect of the present invention;

FIG. 21 is a side view of the articulating neck of the wind instrument 703, according to an exemplary aspect of the present invention; and

FIGS. 22A-22F are a top, bottom, and four side views, respectively, of a foot pedal interface for the instruments 701, 702 and 703, according to an exemplary aspect of the present invention;

### DETAILED DESCRIPTION OF THE EXEMPLARY EMBODIMENTS OF THE INVENTION

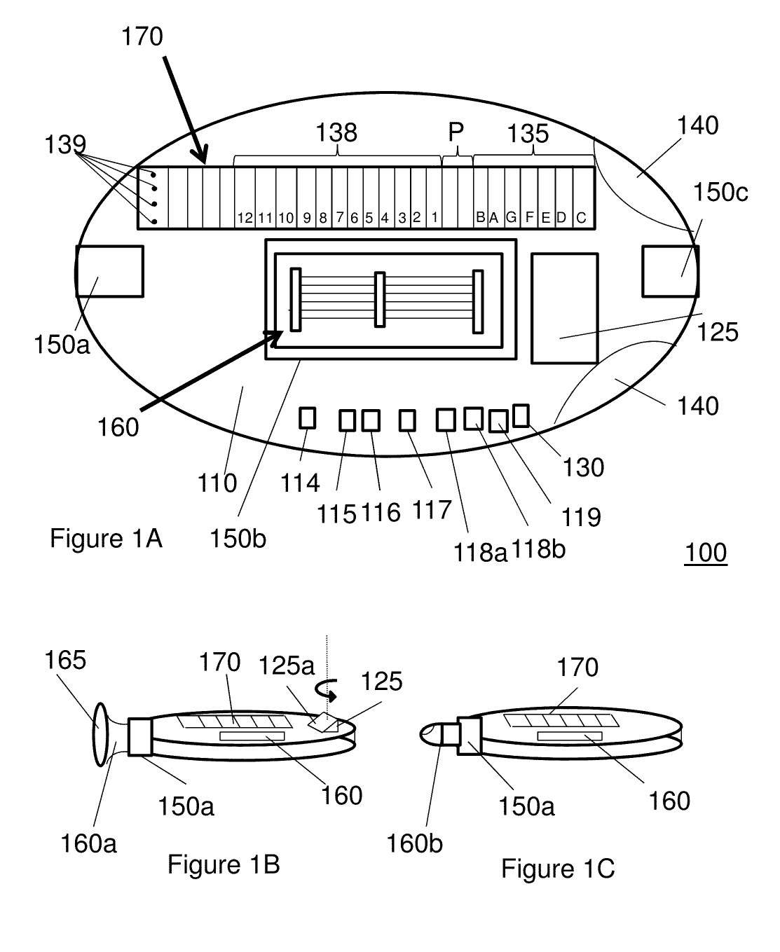

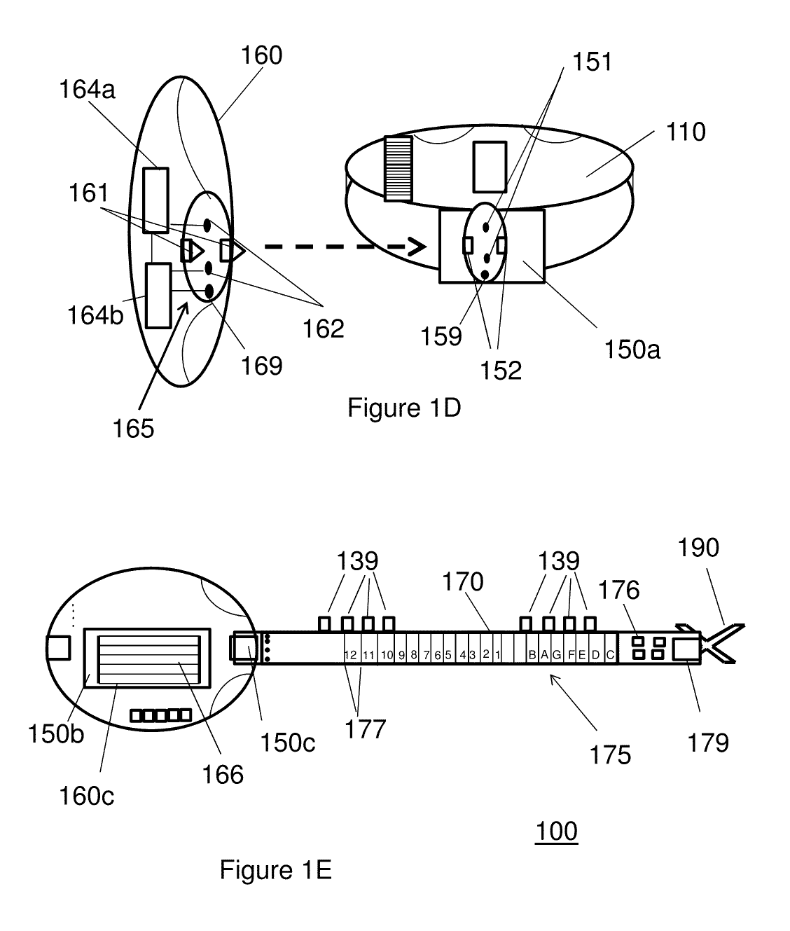

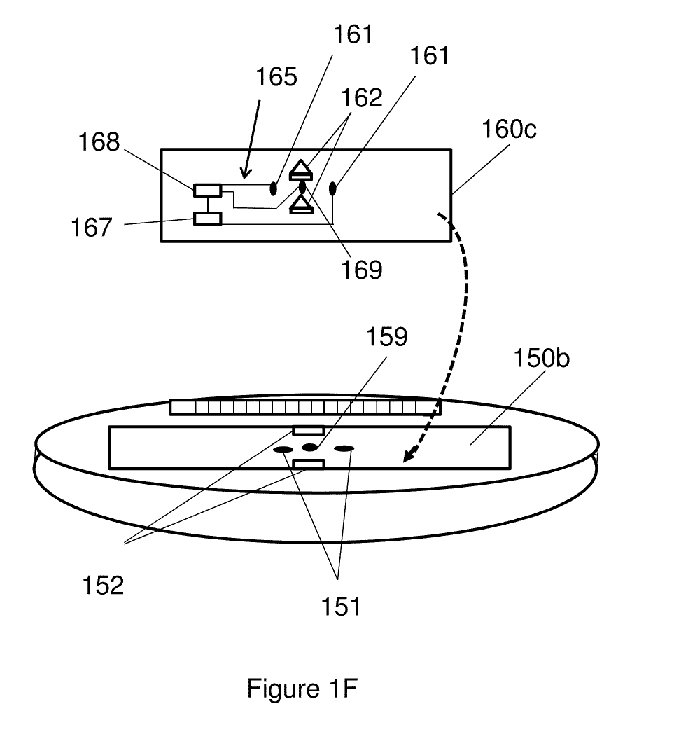

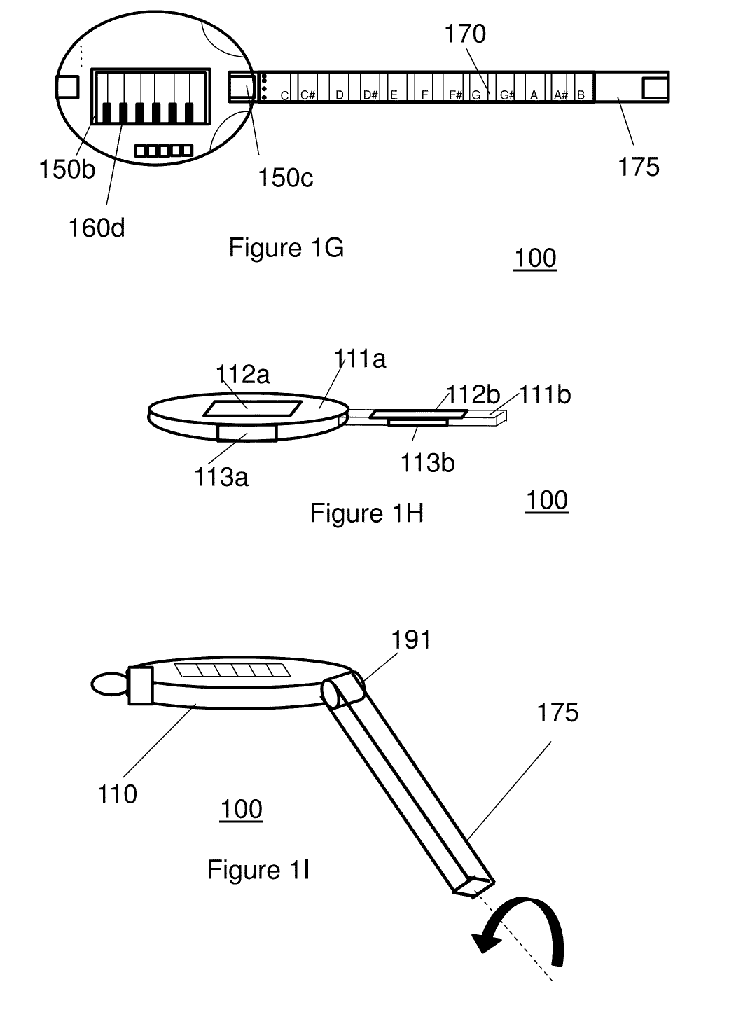

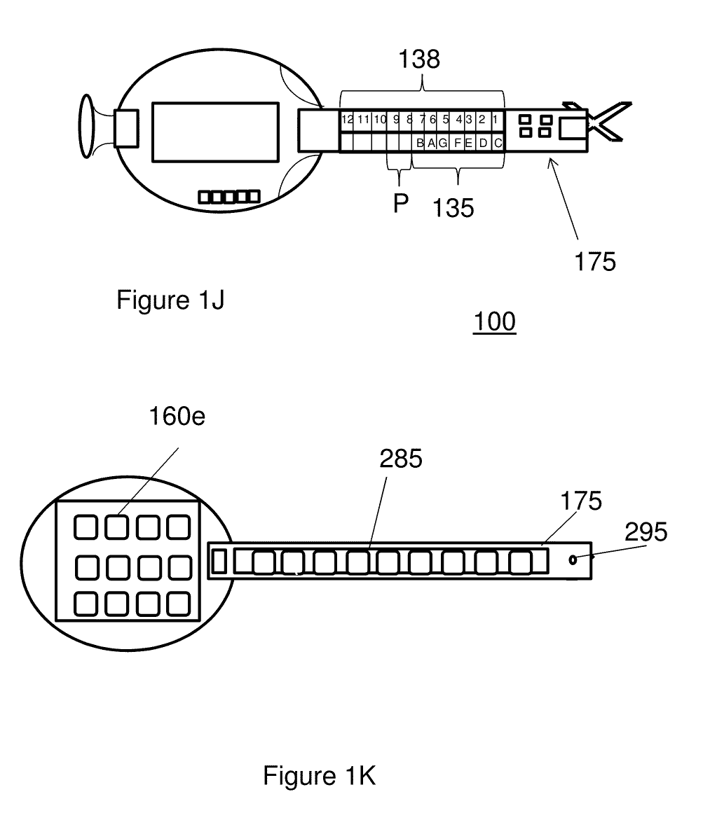

Referring now to the drawings, FIGS. 1A-22F illustrate the exemplary aspects of the present invention.

A problem with a traditional music device is that mastering the device typically requires years of training, and thus, involves a great deal of time and expense. Electric music devices (e.g., electronic versions of traditional music devices) such as the piano and the guitar, have been developed. However, these electric versions have basically the same structure as their traditional counterpart, and are all played by a user in basically the same manner as the traditional music device.

For example, as with a traditional (e.g., acoustic) guitar, a user of an electric guitar must be able to finger the correct chords and strum the correct strings, etc., and as with a traditional piano, a user of an electric piano must be able to depress the correct keys for producing a musical chord. Therefore, as with traditional music devices, mastering an electric music device requires years of training, and thus, involves a great deal of time and expense.

Further, a traditional device (e.g., a piano) is capable of playing only a limited number (e.g., a small number) of musical notes. For example, a traditional piano includes twelve (12) keys (e.g., per octave), and a traditional guitar includes only six (6) strings.

The exemplary aspects of the present invention may address the problems of the prior art devices.

FIGS. 1A-1K illustrate a music device 100 for making music, according to an exemplary aspect of the present invention. The music device 100 may allow users (e.g., musicians and composers) to become proficient at playing music in much less time and with fewer physical requirements than with conventional musical instruments.

As illustrated in FIG. 1A, the music device 100 includes a first input part 160 for generating a first signal based on a user input, a music signal generator 130 for generating a music signal based on the first signal, and a second input part 170 for generating a second signal based on a user input, the second signal controlling the music signal generator 130, and the second input part 170 including a plurality of first buttons 135 (e.g., touch sensitive surfaces, keys, knobs, levers, pedals, switches, slides, etc.) which correspond to a range including at least one of a key, a note and a chord (e.g., a mode such as the key of “C”), and a plurality of second buttons 138 which correspond to at least one of a note and a musical scale within the range (e.g., a submode for operating within the mode selected by the user, such as one of twelve notes from a chromatic scale).

The second input part 170 of the music device 100 may also include a plurality of third buttons 139 for defining a variation of the range or musical variables of the plurality of first buttons 135, and a plurality of fourth buttons P which include a programmable function for varying at least one of chord, pitch and octave or other frequency, tonal or musical variables.

It should be noted that in FIG. 1A, a string instrument input module 160c is illustrated as the first input part 160. However, the first input part 160 may include one or more of the string instrument input module 160c, a brass instrument input module 160a (as illustrated in FIG. 1B), woodwind instrument input module 160b (as illustrated in FIG. 1C), a keyboard instrument input module 160d (as illustrated in FIG. 1G), or a percussion instrument input module 160e (as illustrated in FIG. 1K).

In addition, although the second signal is described herein as controlling the music signal generator 130, it should be noted that the second signal may adjust the music signal which is generated by the music signal generator 130 to provide a similar effect, or in another aspect, the music device 100 may include a music signal adjuster and the second signal from the second input part 170 may control the music signal adjuster to provide a similar effect.

In the music device 100, a first button 135 of the plurality of first buttons may be touched by the user to select a key/chord mode of operation for the music device 100 (e.g., the key of “C”), and a second button 138 of the plurality of second buttons 138 may be touched by the user to select a note submode from one of the twelve notes in a chromatic scale within the key/chord mode selected by the user (e.g., a “G” note). In this case, for example, if a user plucks, strums or pulls a bow across the strings in the string instrument input module 160c (as illustrated in FIG. 1A), then the music signal generator 130 may generate a music signal corresponding to a “G” note (e.g., a “G” note having perfect frequency) in the key of “C” from a string instrument (e.g., guitar, violin, banjo, etc.), or if a user blows on the mouthpiece of the brass instrument input module 160a (as illustrated in FIG. 1B), then the music signal generator 130 may generate a music signal corresponding to a “G” note (e.g., a “G” note having perfect frequency) in the key of “C” from a brass instrument (e.g., trumpet, tuba, French horn, etc.), or if the user blows on the mouthpiece of the woodwind instrument input module 160b (as illustrated in FIG. 1C), then the music signal generator 130 may generate a music signal corresponding to a “G” note (e.g., a “G” note having perfect frequency) in the key of “C” from a woodwind instrument (e.g., clarinet, saxophone, oboe, etc.), if a user depresses a key of the keyboard instrument input module 160d (as illustrated in FIG. 1G), then the music signal generator 130 may generate a music signal corresponding to a “G” note (e.g., a “G” note having perfect frequency) in the key of “C” from a keyboard instrument (e.g., piano, organ, etc.), or if a user strikes the head of the percussion instrument input module 160e (as illustrated in FIG. 1K), then the music signal generator 130 may generate a music signal corresponding to a “G” note (e.g., a “G” note having perfect frequency) in the key of “C” from a percussion instrument (e.g., piano, organ, xylophone, chime, bell, etc.).

The music device 100 may also include a body 110, and an electronic module (e.g., electrical circuit) formed in the body 110. The electronic module may include a microcontroller which is controls an operation and programming of the music device 100. The electronic module may also include the music signal generator 130 for generating the music signal.

The first input part 160 and/or the second input part 170 may be formed on the body 110 as illustrated in FIG. 1A.

As illustrated in FIG. 1E, the music device 100 may also include a neck 175. The first input part 160 and/or the second input part 170 may also be formed on the neck 175.

Further, the location of the plurality of first and second buttons 135, 138 on the body 110 and/or neck 175 is not limited. For example, as illustrated in FIG. 1A, the plurality of second buttons 138 may be formed in a longitudinal direction (e.g., a longitudinal direction of the neck 175) from the plurality of first buttons 135.

Alternatively, as illustrated in FIG. 1J, the plurality of second buttons 138 may be formed in a lateral direction (e.g., substantially perpendicular to a longitudinal direction of the neck 175) from the plurality of first buttons 135. The arrangement of the plurality of first and second buttons 135, 138 in FIG. 1J may be especially effective for using the music device 100 as a brass instrument or woodwind instrument, in which case a user may hold the neck 175 with both left and right hands.

Further, the body 110 may also include an output part 140 which may output the music signal (e.g., a speaker, amplifier, recorder, etc.). The output part 140 may be formed in the body 110 and may include, for example, a sound generator (e.g., speaker receiving the music signal from the music signal generator 130) or an output device for outputting the music signal to an external speaker. The sound generator may generate a sound corresponding to one of a string instrument, woodwind instrument, brass instrument and keyboard instrument, or a combination of any of these instruments based on the music signal.

The body 110 may also include core electronics, processing and interface modules. For example, the body 110 may also include a power source 115 such as a battery pack or a connection (e.g., by a power cord) to an external power source (e.g., standard electrical power source AC or DC). The body 110 may also include a selector 116 for selecting the music signal to correspond to one of a string instrument, woodwind instrument, brass instrument and keyboard instrument, or a combination of any of these instruments.

The second input part 170 of the body 110 may also include an aural feature setting selector 117, for fine-tuning an aural feature the first input part 160 and/or the second input part 170. The aural feature setting selector 117 may be used by the user to fine-tune a musical key, a note, a chord, a pitch, a pitch class, a scale or an octave to be played by the music device 100.

In particular, the aural feature setting selector 117 may be used by the user to select an aural feature setting for the second input part 170 from among a plurality of aural feature settings. The aural feature setting selector 117 may include at least one of a array of musical parameters or variables such as key setting selector, a note setting selector, a chord setting selector, a pitch setting selector, a pitch class setting selector, a scale setting selector and an octave setting selector.

The body 110 may also include a transceiver 118a which may allow the music device 100 to wirelessly communicate with external devices, and a port 118b (e.g., a Universal Serial Bus (USB) port, parallel port, serial port, etc.) for connecting a wire (e.g., parallel cable, serial cable, ethernet cable, coaxial cable, HDMI cable, etc.) to the body 110 so that the music device 100 may communicate with an external device by wire.

For example, the port 118b may include a musical instrument digital interface (MIDI) port which is electrically connected to the music signal generator 130, for communicating an event message about musical notation, pitch, velocity, control signals for parameters (such as volume, vibrato, audio panning, cues, and clock signals (e.g., to set and synchronize tempo) between the musical device 100 and an external device.

The body 110 may also include additional inputs such as switches, dials, audio jacks, etc. which are not illustrated in FIG. 1A. In addition, the music signal generated by the music signal generator 130 (e.g., electronic module) may include a digital and/or an analog signal, allowing for different output interfaces to various devices including amplifiers, computers, recording equipment and any device that can accept the specific analog or digital outputs of the exemplary aspects of the present invention.

As illustrated in FIGS. 1A and 1B, the body 110 may also include a display device 125 formed on a surface of the body 110, for displaying musical compositions (e.g., notes, chords and melodies of songs, a musical notation corresponding to at least one of the plurality of first buttons and the plurality of second buttons, or other parameters such as lyrics, rhythm, time signatures or any other pertinent information).

In addition, as illustrated in FIG. 1B, the display device 125 may include a display surface 125a which projects from the body 110 (e.g., a main surface of the body) so that the user can conveniently read the musical composition displayed on the display surface 125a while playing the music device 100. In addition, the display device 125 may be rotatable by the user as indicated by the arrow in FIG. 1B, so that the display surface 125a can face a desired direction if the user is playing the music device 100 as a brass instrument, for example, and could be rotated to face a different direction if the user is playing the music device 100 as a string instrument, etc.

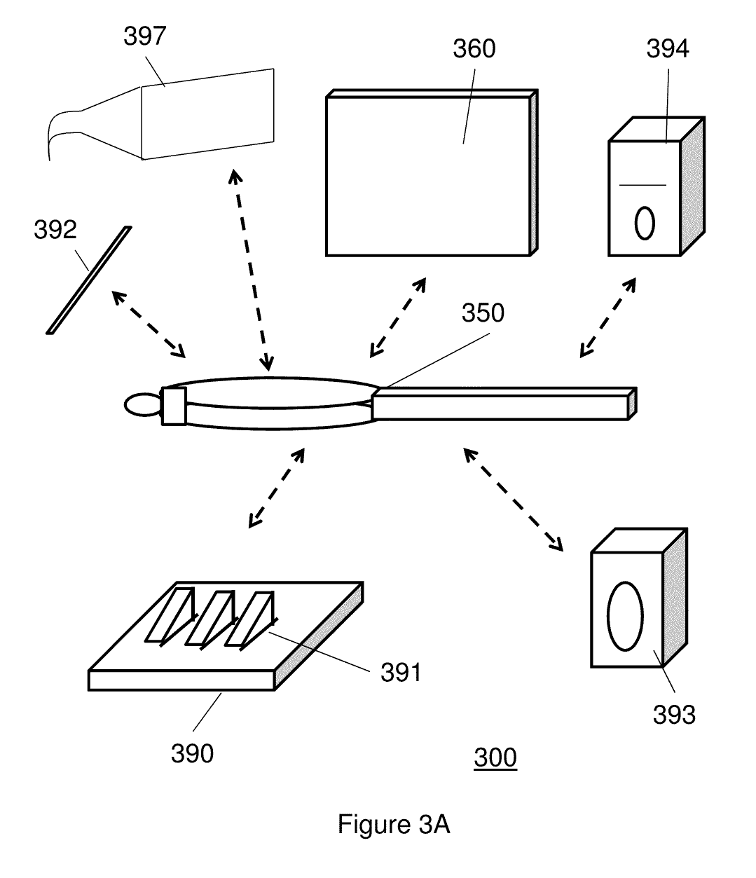

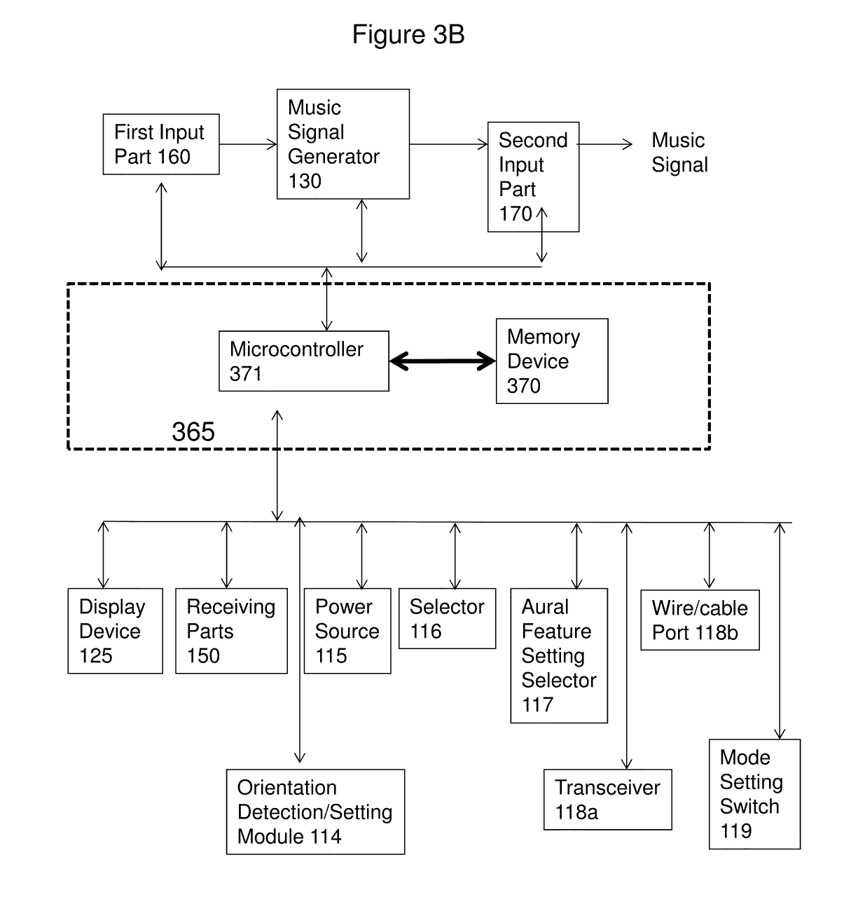

In addition, the electronic module (e.g., circuit including the music signal generator) of the music device 100 may include a memory device 370 (e.g., solid state memory device such as random access memory (RAM)) which stores musical compositions, and a microcontroller (e.g., see FIG. 3B below) which may access the memory device 370 in order to cause the display device 125 to display the musical compositions. The music device 100 may also include input devices formed on the body 110 which allows the user to control a display on a display screen of the display device 125.

In particular, the display device 125 may display a musical notation which may be read by the user to use the music device 100. The musical notation may include, for example, a novel notation which may indicate a chord/key, a note within that chord/key, and a duration of the note. That is, with the music device 100, a user does not need to know and the display does not need to display conventional musical notation such as a musical staff, whole notes, quarter notes, rest symbols, etc. Thus, the musical notation displayed on the display device 125 may include only a chord/key, a note within that chord/key, and a duration of the note.

The body 110 may also include a mode setting switch 119 for setting (e.g., selecting) a mode of the music device 100 from among a plurality of modes. For example, the music device 100 may include a programming mode in which the music device may be programmed such as by an external device (e.g., a computer connected to the music device 110 via a wireless connection (e.g., Bluetooth) or by wire via the port 118b), or by using a keyboard formed on the body 110. For example, the display device 125 may include a touchscreen and the keyboard may be displayed on the touchscreen of the display device 125. The music device 100 may also include a left hand play mode, a right hand play mode, an acoustic instrument mode, an electrical/electronic instrument mode, and an acoustic/electronic hybrid instrument mode.

The body 110 may also include receiving parts 150a, 150b and 150c for receiving the first input part 160 (e.g., see FIGS. 1A-1C). The first input part 160 may be fixed to the body 110 (e.g., integrally formed with the body 110 by a fastener such a screw, etc.) or may be detachably connected to the receiving parts 150a, 150b, 150c of the body 110 (e.g., removably connected to the body 110). The second input part 170 may also be fixed to the body 110 (e.g., integrally formed with the body 110 by a fastener such a screw, etc.) or may be detachably connected to a receiving part (not shown) of the body 110 (e.g., removably connected to the body 110).

The music signal generated by the music signal generator 130 may be received by the output part 140 (e.g., sound generator, speaker, amplifier, output device for outputting the music signal to an external speaker) and cause the output part 140 to produce a sound (e.g., a sound such as chords, notes, pitches) which simulates the sound of a traditional musical instrument, and may also produce additional sounds (e.g., hybrid sounds, such as the sound of a combination of a trumpet and piano) which a traditional musical instrument is not capable of producing. More particularly, the music device 100 may include a hybrid traditional and electronic, analog and digital musical instrument in the traditional instrument categories of bowed strings, woodwinds, brass, keyboard and guitar, or a completely digital input musical instrument that may radically differ from traditional musical instruments. The music device 100 may provide a new methodology and system for creating musical, tonal and sound variations.

Due to its design, attributes and methodologies, the music device 100 can be more ergonomically designed, less physically demanding and more easily played by individuals with a larger variation of human hand sizes, finger strengths, arm lengths, breath capacities and physical characteristics. The music device 100 may facilitate easier learning, playing, composing and performing of music than traditional musical instruments, which would allow for more future musicians and composers of wider ages, physical variations and experience levels.

The music device 100 may completely eliminate a chance of improperly playing a desired chord, note, pitch or other variation, and may allow musicians and composers to easily and in much shorter timeframes become proficient at playing music, thus freeing the user to focus on creating, composing, playing, performing, and/or sharing music.

In an exemplary aspect, the music device 100 may provide a new system for making music, and more specifically, may allow a user to change the musical parameters (tonal or sounds) of keys, notes, chords, pitch or pitch class, scales and octaves in real time (e.g., on the fly). The music device 100 may provide a series of electronic, microprocessor or “machine intelligent” hybrid analog and or digital musical instruments in the traditional categories of string (e.g., guitar, violin, cello, etc.), woodwind, brass and keyboard instruments.

The music device 100 may use different combinations or variations of input components, keys, switches, buttons, strings or touch sensitive zones to change musical parameters (e.g., musical or tonal) of keys, notes, chords, pitch or pitch class, scales and octaves (e.g., on a fixed or removable neck). The music device 100 may emulate the traditional musical instrument categories of string (e.g., guitar, violin, cello, etc.), woodwind, brass and keyboard instruments. As described in more detail below, the music device 100 may allow for variations not possible by traditional instruments or conventional electronic instruments (e.g., synthesized instruments, such as an electronic guitar or electronic piano).

Additionally, the music device 100 may include a common methodology for producing, changing and terminating tonal keys, notes, octaves, pitches or tonal key, note or any sound variations and parameters. Thus, with the music device 100, a musician (e.g., a beginning musician) may be able to learn these different instruments more easily and faster by virtue of the methodologies and commonality between the instruments.

Referring again to FIG. 1A, the second input part 170 may include a touch sensitive surface. Thus, for example, a user may touch the touch sensitive surface of the second input part 170 at a location at of a first button 135 in order to generate a second signal corresponding to the first button 135, and so on. In particular, the touch sensitive surface may include a touch screen for displaying the plurality of first buttons 135, the plurality of second buttons 138 and the plurality of third buttons 139 and the plurality of fourth buttons P. In this case, for example, a user may touch the touch sensitive surface of the second input part 170 at a location at which a first button 135 is displayed in order to generate a second signal corresponding to the first button 135, and so on.

The first input part 160 may include a structural element of a brass instrument (e.g., a brass instrument mouthpiece), woodwind instrument (e.g., a woodwind instrument mouthpiece), string instrument (e.g., strings for a string instrument) or keyboard instrument (e.g., a piano keyboard). The first input part 160 may be used by the user to control sound creation parameters of input including, but not limited to, loudness, duration, location variation, velocity, pressure, rhythm, strumming-keyboarding-bowing-blowing patterns, pitch bending, vibrato, tremolo, deadening, plucking, slapping and buzzing, etc.

For example, by plucking harder on the strings of the string instrument input module 160c in FIG. 1A, a user may cause the music signal generator 130 to generate a music signal corresponding to a louder sound, and by plucking softer on the strings of the string instrument input module 160c in FIG. 1A, a user may cause the music signal generator 130 to generate a music signal corresponding to a softer sound, by blowing harder (e.g. increased air pressure, velocity, etc.) on the brass instrument input module 160a of FIG. 1B, a user may cause the music signal generator 130 to generate a music signal corresponding to a louder sound, and by blowing softer (e.g. increased air pressure, velocity, etc.) on the brass instrument input module 160a, a user may cause the music signal generator 130 to generate a music signal corresponding to a softer sound, and so on.

The second input part 170 may be used by the user to provide a methodology for setting and/or adjusting a sound parameter which may be radically different than any conventional acoustic or electronic (e.g., synthesized) music device (e.g., musical instrument). In particular, the parameters which may be set by the first plurality of buttons 135 of the second input part 170 may include but are not limited to, musical key A thru G (including harmonic center or tonic), chords (including major, minor, sharp, flat, diminished, augmented, slash, power, dominant), pitch (including harmonics, frequency), and octave (twelve semitones).

The parameters which may be set by the second plurality of buttons 138 include scales (including chromatic, whole tone, pentatonic, diminished, diatonic, accidentals), and notes.

The parameters which may be set by the third plurality of buttons P include effects (including accent, sustain, distortion, dynamics, filters, modulation, time-based, reverb, feedback).

The plurality of fourth buttons P may be programmed, for example, to provide a fine adjustment of the key/chord set by the user by touching a button of the plurality of first buttons 135. Alternatively, the plurality of fourth buttons P may be programmed to provide other effects such as accent, sustain, distortion, dynamics, filters, modulation, time-based, reverb and feedback.

Importantly, the plurality of first, second, third and fourth buttons, 135, 138, 139, P may be programmable by the user. This may allow the music device 100 to be customized to the unique needs of the user. For example, if a user generally plays music only the key of “C”, the user can program the music device 100 to eliminate other keys (e.g., D, E, F, etc.) from the other plurality of first buttons 135, in which case the remaining plurality of first buttons 135 may be programmed to be dedicated for some other use (e.g., effects such as accent, sustain, distortion, dynamics, filters, modulation, time-based, reverb and feedback).

Further, the settings of the music device 100 may be stored in a memory device (e.g., memory device 370 for one or more users. Thus, for example, a first player may program the music device 100 to include his settings (e.g., first input part setting, second input part setting, etc.), and a second player may program the music device 100 to include his settings. Then, the first player may select first player mode using the mode setting switch 119 in which case, the music device 100 will be set to the settings of a first player, and the second player may select second player mode using the mode setting switch 119 in which case, the music device 100 will be set to the settings of a second player, and so on.

Further, as illustrated in FIG. 1A, the music device 100 may be programmed such that plurality of first buttons 135 may include the first seven subdivisions (e.g., the seven buttons which are furthest from the body 110), and are primary (tonic, key of instrument's tune) or secondary (key or major chord of sound or music being played) musical keys A through G inputs. Further, the plurality of fourth buttons P may be formed adjacent to the plurality of first buttons 135 in a longitudinal direction, and may be programmable for variations including, but not limited to, chords, pitch, and octave. Further, the plurality of second buttons 138 may be adjacent to the plurality of fourth buttons P in a longitudinal direction, and may include twelve input/output subdivisions which are programmed for the solo note play in the selected key (e.g., the key selected by the user by touching a button of the plurality of first buttons 135), chromatic scales or twelve octave semitones. In addition, the plurality of third buttons 139 which may be formed on the body 110 as illustrated in FIG. 1A, or may be formed on a side of the neck 175 as illustrated in FIG. 1E. The plurality of third buttons 139 may be programmed, for example, to provide a fine adjustment of the key/chord set by the user by touching a button of the plurality of first buttons 135. For example, a user may touch a third button 139 to cause the music device 100 to play in a “key” which is between the key of “C” and the key of “D”. Alternatively, the plurality of third buttons 139 may be programmed to provide other effects such as accent, sustain, distortion, dynamics, filters, modulation, time-based, reverb and feedback.

With the music device 100, if the user selects a C chord, then the music signal generator 130 may generate a music signal for creating a perfect C chord, regardless of a musical abilities, experience and talents of the user, regardless of the placement within the C chord section, and regardless of the force used by the user. If the user switches from a C chord to an Am7 and the input sequence is correct, then the music signal generator 130 may generate a perfect Am7 chord, again regardless of a musical abilities, experience and talents of the user, and regardless of the placement within the Am7 chord section, the force used by the user.

Further, the user may use the plurality of second buttons 138 to operate in a solo note section. For example, by selecting a button of the plurality of second buttons, a user may cause the music signal generator to generate a note within the twelve variations of the chromatic scale to be played, and moreover, the note may be perfectly based on the key/chord selected by the user by touching one of the plurality of first buttons 135. In short, each variation played by the user may be perfect tonally and musically.

Further, the first and second input parts 160, 170 of the music device 100 may be programmed to a unique desire of a user. For example, a user may program the music device 100 to have a first setting in which a button of the plurality of second buttons 138 includes C (e.g., C4 in the chromatic scale), C#, D and D# which are depressed by a user to cause the music signal generator 130 to generate a music signal corresponding to a musical notes C, C#, D and D# respectively (i.e., sounds having frequencies of 261.63 Hz, 277.18 Hz, 293.67 Hz and 311.13 Hz, respectively).

Alternatively, a user may desire to play particular parts (e.g., notes) of the music device 100 “out of tune” or “off key” in some circumstances. In this case, for example, the user may program the music device 100 to have a second setting such that a button of the plurality of second buttons 138 may be depressed by a user to cause the music signal generator 130 to generate a music signal corresponding to a sound which is other than a frequency of a musical note of the musical scale (e.g., other than notes C, C#, D and D#). Thus, for example, a second button of the plurality of second buttons 138 may be depressed to generate a sound having a frequency between 261.63 Hz and 277.18 Hz, another second button of the plurality of second buttons 138 may be depressed to generate a sound having a frequency between 277.18 Hz and 293.67 Hz, and so on.

Further, the user may touch a third button of the plurality of third buttons 139, or a fourth button of the plurality of fourth buttons P, to “tweak” the settings of the plurality of first and second buttons 135, 138 in real time (e.g., to adjust the settings “on the fly”). Thus, for example, a user may be playing in the first setting (e.g., playing notes C, C#, D and D#), and may touch a third button of the plurality of third buttons 139, or a fourth button of the plurality of fourth buttons P to change to the second setting (e.g., playing other than notes C, C#, D and D#).

Referring again to the drawings, FIG. 1B illustrates the music device 100 configured to include a first input part 160 in the form of a brass instrument input module 160a (e.g., brass instrument mouthpiece) connected to the receiving part 150a, and FIG. 1C illustrates the music device 100 configured to include first input part 160 in the form of a woodwind instrument input module 160b (e.g., woodwind instrument mouthpiece) connected to the receiving part 150a.

The input module 160a may have a shape and function similar to that of a mouthpiece of a conventional brass instrument (e.g., French horn, trumpet, trombone and tuba), and the input module 160b may have a shape and function similar to that of a mouthpiece of a conventional woodwind instrument (e.g., bassoon, clarinet, flute, oboe and saxophone, harmonica, bagpipe, etc.).

The first input part 160 may include systems or intelligence imbedded therein which may operate with the music device 100 to recognize multiple parameters of the music device 100, including but not limited to left or right-handed designation and type of conventional instrument emulation, electrification or non-electrification, lighted or non-lighted, etc.

FIG. 1D illustrates an exemplary connection between a brass instrument input module 160a (e.g., first input part 160) and a receiving part 150a of the body 110. As illustrated in FIG. 1D, the input module 160a (e.g., first input part 160) includes metal contacts 161 and a first portion 162 of a fastening structure (e.g., snap, clip, clamp, screw, hole, etc.), and the receiving part 150a includes metal contacts 151 which mate with the metal contacts 161 to complete an electrical connection between the brass instrument input module 160a and the receiving part 150a.

The metal contacts 151 and 161 may also be used to transmit power from the power source 115 in the body 110 to the brass instrument input module 160a. In addition, the input module 160a includes a metal contact 169 and the receiving part 150a includes a metal contact 159 which may be used to transmit the second input signal which is generated in the input module 160a to the body 110.

It should be noted that the drawings are only exemplary and should not be considered as limiting. That is, the first input part 160 and the receiving part 150a may include any number of metal contacts for transmitting power from the body 110 to the first input part 160, and for transmitting the second input signal from the first input part 160 to the body 110. In addition, it should be noted that a portion of the circuit 165 (e.g., filter, amplifier, etc.) for generating the second input signal may also be located in the body 110 instead of in the first input part 160.

In addition, the receiving part 150a includes a second portion 152 (e.g., connecting part 152) of a fastening structure (e.g., snap, clip, clamp, screw, hole, etc.) which is configured to mate with the first portion 162 in order to securely and detachably connect the brass instrument input module 160a to the receiving part 150a of the body.

FIG. 1D also illustrates a circuit 165 for sensing and transmitting an input in the brass instrument input module 160a. The circuit 165 includes a pressure transducer 164a which is connected to the metal contacts 161 and senses a pressure in the input module 160a and generates an electrical current representative of the pressure, and a processing circuit 164b for processing the current from the transducer 164a into the second input signal.

The pressure transducer 164a may be used to convert the pressure inside the input module 160a (e.g., mouthpiece) which is caused, for example, by a user blowing into the hole 165 (e.g., see FIG. 1B) of the input module 160a. The input module 160a may also include another hole (not shown) which may allow air to exit the input module 160a and the user is blowing into the hole 165. The pressure transducer 164a may produce an electrical signal by measuring a change in one of capacitance, resistance and inductance in response to the pressure inside the input module 160a. For example, the pressure transducer may include a capacitor such that the pressure inside the input module 160a pushes a plate of the capacitor closer to another plate causing a change a capacitance of the capacitor, or the pressure transducer 164a may include a strain gauge attached to a diaphragm, and the pressure may distort the diaphragm causing a change in resistance of the strain gauge, and so on.

A structure and operation of the woodwind instrument input module 160b may be similar to the structure and operation of the brass instrument input module 160a described above.

FIG. 1E illustrates the music device 100 configured to include a neck 175 (e.g., similar to a guitar neck, violin neck, cello neck, etc.) for a string instrument (e.g., a guitar neck), which is connected to receiving part 150c. As illustrated in FIG. 1E, the second input part 170 may be formed on the neck 175.

Similar to the first input part 160, the neck 175 includes metal contacts 161 and a first portion 162 of a fastening structure (e.g., snap, clip, clamp, screw, etc.), and the receiving part 150c includes metal contacts 151 which mate with the metal contacts 161 to complete an electrical connection between the neck 175 and the receiving part 150c. In addition, the receiving part 150c includes a second portion 152 of the fastening structure (e.g., snap, clip, clamp, screw, etc.) which is configured to mate with the first portion 162 in order to securely and detachably (e.g., and rotatably) connect the neck 175 to the receiving part 150c of the body 110.

Similar to the body 110, the neck 175 may also include core electronics, processing and interface modules. For example, the neck 175 may also include a power source such as a battery pack or a connection (e.g., by a power cord) to an external power source (e.g., standard AC or DC electrical power source). The neck 175 may also include a selector for selecting the music signal to correspond to one of a string instrument, woodwind instrument, brass instrument and keyboard instrument. The neck 175 may also include systems or intelligence imbedded therein which may operate with the music device 100 to recognize multiple parameters of the music device 100, including but not limited to left or right-handed designation and type of conventional instrument emulation, electrification or non-electrification, lighted or non-lighted, etc.

As illustrated in FIG. 1E, the subdivisions of the neck 175 (e.g., the plurality of first and second buttons 135, 138) may be separated, for example, by the plurality of fret 177 emulators (e.g., shown in FIG. 1E as a line separating the plurality of first and second buttons 135, 138). The fret emulators 177 may include, for example, a raised surface on a surface of the neck 175, or a lighted surface (e.g., which may be illuminated by a plurality of light-emitting diodes formed in the neck 175).

The neck 175 may also include an aural feature setting selector, for selecting an aural feature setting for the first input part (e.g., and other input parts described below), from among a plurality of aural feature settings, the aural feature setting selector includes one of a musical key setting selector, a note setting selector, a chord setting selector, a pitch setting selector, a pitch class setting selector, a scale setting selector and an octave setting selector. The neck 175 may also include inputs such as switches, dials, a Universal Serial Bus (USB), parallel ports and serial ports, and may also include outputs such as audio jacks, wireless transmitters, etc.

Further, the neck 175 may be connected to the receiving part 150a or the receiving part 150c, which may allow the user to configure the music device 100 as a primarily left-handed or right-handed instrument. This may allow the music device 100 to be arranged in a right-handed mode or a left-handed mode. Further, the music device 100 may be symmetrically configured for either left or right-hand use.

As illustrated in FIG. 1E, the neck 175 may also include a touch-sensitive input/output zone 176 formed on a main surface of the neck 175 (e. g., a surface which is coplanar with a main surface of the body 110), the plurality of fret emulators 177 formed on the main surface, and other input structures (e.g., switches, keys, buttons, etc.) which may be formed on a side of the neck 175.

The neck 175 may also include a receiving part 179, and a logo 190 which is detachably connected to the receiving part 179. The logo 190 may be connected to the receiving part 179 in a manner similar to that described with respect to FIG. 1F. The logo 190 may be fixed or detachable, interchangeable, electronic or non-electronic, electrifiable (for lighting or other electrified applications), personalized-identifier, standard or customizable logo or shape. The logo 190 may include systems or intelligence imbedded therein which may operate with the music device 100 to recognize multiple parameters of the music device 100, including but not limited to left or right-handed designation and type of conventional instrument emulation, electrification or non-electrification, lighted or non-lighted, etc.

The logo 190 may also be equipped with electronics for providing a “handshake” protocol between the logo 190 and neck 175. With such a protocol, the electronic module of the music device 100 may be required to detect a recognized handshake signature of the logo 190 in order for the logo 190 to connect properly to the neck 175 and operate properly. Other features of the music device 100 may also include such a handshake signature (e.g., the neck 175, the brass instrument input module 160a, etc.).

In addition to the second input part 170 (or instead of the second input part 170) the neck 175 may include a touch sensitive surface. In particular, the touch sensitive surface may include a touchscreen (e.g., a display screen with a touch sensitive surface) for displaying features for generating an input signal which may be used by the music signal generator 130 to generate the music signal. For example, a touch sensitive surface on the neck 175 may display a plurality of first buttons 135, a plurality of second buttons 138, and a plurality of fourth buttons P (e.g., similar to the second input part 170). That is, for example, a user may touch the touch sensitive surface of the neck 175 at a location at which the first button 135 is displayed in order to generate a second input signal corresponding to the first button 135, and so on.

Further, as illustrated in FIG. 1E, the first input part 160 may also include a string instrument input module 160c as another structural element of the stringed instrument (e.g., guitar). The string instrument input module 160c may be connected (e.g., electrically connected and physically connected) to receiving part 150b on the body 110 in a manner which is similar to the manner described above with respect to FIG. 1D (e.g., see FIG. 1F).

Further, the first input part 160 (e.g., the brass instrument input module 160a, woodwind instrument input module 160b, string instrument input module 160c and keyboard instrument input module 160d) may include both electronic and traditional acoustic features.

Thus, for example, a user may select acoustic mode (e.g., using the mode setting switch 119) which causes the first input part 160 to operate in an acoustic mode causing the music signal generator 130 to generate a music signal corresponding to an acoustic instrument. For example, if the string instrument input module 160c is connected to the body 110, and acoustic mode is selected by the user, then the music signal generator 130 may generate a music signal corresponding to an acoustic guitar, acoustic violin, etc.

The acoustic features of the string instrument input module 160c may include, for example, a soundboard (e.g., wooden piece mounted on the front of the body 110) which amplifies the sound generated by a sound generator which is connected to the strings of the module 160c, to generate a sound of an acoustic guitar.

Thus, in the music device 100 of FIG. 1E, the music signal generator 130 of the electronic module may generate the music signal based on one of more of the first input signal generated by the second input part 170, and the second input signal generated by the string instrument input module 160c. Alternatively, the neck 175 may also include a third input part formed thereon, in which case, the music signal generator 130 may generate the music signal based on one or more of a first input signal generated by the second input part 170, a second input signal generated by the string instrument input module 160c, and a third input signal from the third input part formed on the neck 175.

The body 110 may also include a vibrato lever (e.g., whammy bar) which is connected to the input module 160c, and may enable a user to quickly vary the tension and sometimes the length of the strings on the input module 160c temporarily, changing the pitch to create a vibrato, portamento or pitch bend effect.

FIG. 1F illustrates a detailed view of a bottom surface of the string instrument input module 160c which is to be connected to the receiving part 150b. The string instrument input module 160c may include a plurality of strings 166 (e.g., metal strings) (e.g., see FIG. 1E) and an electrical circuit 165 for generating a second input signal. In particular, the plurality of strings 166 may be electrically connected to a sensor 167 in the circuit 165 for sensing a vibration of the plurality of strings 166 electronically to generate the second input signal.

Similar to the brass instrument input module 160a in FIG. 1D, the string instrument input module 160c may include metal contacts 161 and a first portion 162 of a fastening structure (e.g., snap, clip, clamp, screw, etc.). In addition, input module 160c includes a metal contact 169 and the receiving part 150a includes a metal contact 159 which may be used to transmit the second input signal which is generated in the first input part 160 to the output part 140 in the body 110.

The circuit 165 in the string instrument input module 160c may be similar to a circuit in a conventional electric guitar. For example, the sensor 167 may include a magnetic pickup mounted under the strings on the string instrument input module. The magnetic pickup may include a bar magnet wrapped with a coil, the vibrating strings produces a corresponding vibration in the magnet's magnetic field and therefore a vibrating current in the coil.

The string instrument input module 160c may also include a signal processing circuit 168 (e.g., similar to a traditional electric guitar processing circuit) for processing the current generated in the coil into the second input signal. For example, the processing circuit 168 may include a variable resistor for adjusting a tone of the first input signal, and a low-pass filter for filtering out higher frequencies, and a resistor for controlling an amplitude of the second input signal.

FIG. 1G illustrates a music device 100 configured to include the second input part 170, the neck 175 and a keyboard instrument input module 160d. Thus, in the music device 100 of FIG. 1G, the music signal generator 130 (e.g., the electronic module) may generate the music signal based on one of more of the first input signal generated by the second input part 170, and the second input signal generated by the keyboard instrument input module 160d.

The keyboard instrument input module 160d, may include a circuit similar to circuit 165 in FIG. 1F. The input module 160d may generate the second input signal in a manner which is similar to a manner of generating an input signal in a conventional digital piano, electric piano or electronic piano.

For example, configured as a digital piano, the input module 160d may duplicate the sound and feel of playing an acoustic piano, by producing a digitally-sampled sound signal, and having keys with a weighted key action to imitate the action of an acoustic piano. Configured as an electric piano, the input module 160d may include a metal tine or string which vibrates, and a pickup (e.g., as in an electric guitar) to detect the vibration of the string. Configured as an electronic piano (e.g., electronic keyboard), the input module 160d may include a memory for storing a database of computer-generated sounds, and may generate a computer-generated sound signal based on a selected key on the keyboard of the input module 160d.

Similar to the second input part 170 and the neck 175, the receiving part 150a may be replaced with a touch sensitive surface (e.g., a touchscreen) for displaying the structural elements of a string instrument, woodwind instrument, brass instrument, or keyboard instrument. That is, for example, a user may touch the touch sensitive surface at a location at which the structural element to generate a second input signal corresponding to the structural element.

FIG. 1H illustrates a back surface 111a of the body 110 (e.g., a planar surface formed opposite to a main surface of the body 110 on which the receiving part 150b is formed), and a back surface 111b of the neck 175. As illustrated in FIG. 1H, an access opening 112a (e.g., access door, panel, etc.) may be formed on the back surface 111a, and an access opening 112b may be formed on the back surface 111b of the neck 175. In addition, an access opening 113a may be formed on a side surface of the body 110, and an access opening 113b may be formed on a side surface of the neck 175. For example, internal electronics, boards, systems and peripherals of the music device 100 may be accessed through the access openings 112a, 112b, and 113a, 113b.

FIG. 1I illustrates the music device 100 including a connector 191 for connecting the neck 175 to the body 110. As illustrated in FIG. 1I, the connector may include a rotating mechanism such as a hinge-mechanism or socket for allowing the neck 175 to rotate out of the plane of body 110. For example, the connector 191 may allow the neck 175 to rotate in a range from 0° to 90°, and may include a locking mechanism (e.g., screw, bolt, pin, clip, clamp, etc.) for locking the neck 175 to be at a fixed angle relative to the body 110. This may provide the music device 100 with an appearance similar to a woodwind instrument such as a clarinet or saxophone.

Further, the connector 191 may include a mechanism (e.g., a socket or biaxial hinge) which allows the neck 175 to rotate down and out of the plane of the body 110, and may also allow the neck 175 to rotate side-to-side (e.g., in the plane of the body).

The connector 191 may also include a rotating mechanism for allowing the neck 195 to be rotatable about its longitudinal axis (e.g., the dashed line in FIG. 11) with respect to the body 110, as illustrated by the arrow in Figure 1H.

Further, although the neck 175 is illustrated in FIG. 1I as having a square cylinder shape, the neck 175 may have other shapes including, for example, a plate shape, a circular cylinder shape or a semi-circular cylinder shape.

FIG. 1K illustrates a music device 100 including a percussion instrument input module 160e connected to the receiving part 150b, and a neck 175 connected to receiving part 150c and including a touch sensitive surface 285 displaying the surfaces of a percussion instrument (e.g., drums, xylophone, chimes, cymbals, etc.). The percussion instrument input module 160e may include a head and a circuit which is connected to the head and is similar to a circuit in a conventional electric percussion instrument (e.g., electric drum set).

As illustrated in FIG. 1K, the input module 160e may include a head (e.g., programmable touch-sensitive bar) that can be programmed by the user for various input play modes. As in all of the second input parts 160 (and touch sensitive surfaces 280, 285), the input module 160e may include systems or intelligence imbedded therein which may operate with the music device 100 to recognize multiple parameters of the music device 100, including but not limited to left or right-handed designation and type of conventional instrument emulation, electrification or non-electrification, lighted or non-lighted, etc.

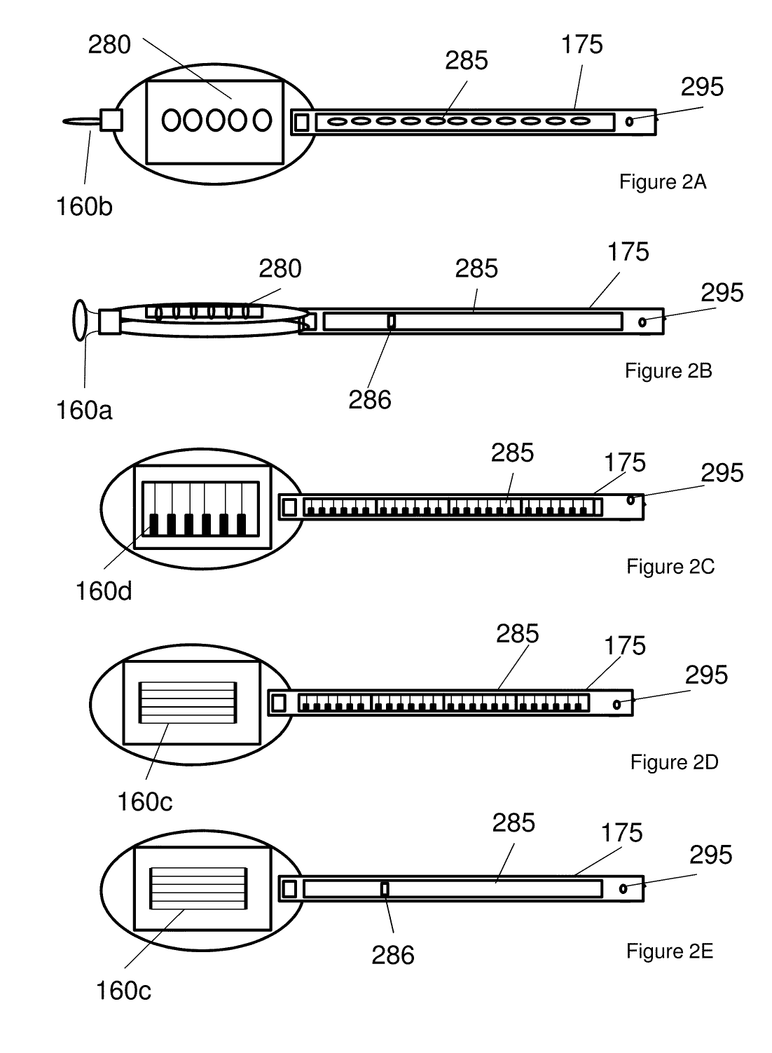

Thus, the music device 100 may include many different configurations. For example, FIGS. 2A-2E illustrate some examples of how the music device 100 may be configured. FIG. 2A illustrates a music device 100 including a touch sensitive surface 280 (e.g., touchscreen formed on the body 110 (e.g., in place of the receiving part 150b), and a woodwind instrument input module 160b connected to receiving part 150a, and a neck 175 connected to receiving part 150c. The neck 175 includes a touch sensitive surface 285 (e.g., touchscreen). In this exemplary aspect, the touch sensitive surface 280 and the touch sensitive surface 285 both display keys of a woodwind instrument such as a clarinet, saxophone, oboe or bassoon.

Further, the keys displayed on touch sensitive surface 280 and/or touch sensitive surface 285 may correspond to the keys of the second input part 170. Thus, for example, by touching a key displayed on the touch sensitive surface 280, 285, the music signal may cause a C note to be generated, by touching a different key the music signal may cause a G note to be generated, and so on.

The touch sensitive surfaces 280, 285 may include a programmable touch-sensitive user interface that can be programmed by the user for various input play modes. For example, the touch sensitive surface 280, 285 may display the keys of a keyboard (e.g., a traditional piano key layout), the valves of a brass instrument, the keys of a woodwind instrument and/or the strings of a string instrument.

Like the second input part 170 and the input modules 160a-160d, the touch sensitive surfaces 280, 285 may include embedded processing or intelligence electronics that interfaces with the electronics of the music device 100 (e.g., see FIG. 3B) in order to identify type of input module, type of instruments to be emulated, left-handed or right-handed mode selection, etc.

A user may use the selector 116 to select an instrument structural element to be displayed on the touch sensitive surface 280 and the touch sensitive surface 285 from among a plurality of structural elements (e.g., clarinet keys, trumpet valves, saxophone keys, piano keys, guitar strings, etc.). In addition, the neck 175 may include a selector 295 for adjusting the display of an instrument structural element to be displayed of the touch sensitive surface 285.

FIG. 2B illustrates a music device 100 including a brass instrument input module 160a connected to the receiving part 150a, a touch sensitive surface 280 which displays the valves of a brass instrument or the keys of a woodwind instrument, and a neck 175 which includes a touch sensitive surface 285 which displays a trombone slide 286. Further, as illustrated in FIG. 2B, the neck 175 may be rotatably connected to the body 110. In particular, the neck 175 may be rotatable about its longitudinal axis so that a planar surface of the touch sensitive surface 285 is substantially perpendicular to a planar surface of the body 110.

As illustrated in FIG. 1A, the body 110 may also include an orientation detection/setting module 114 which detects an orientation of the body 110, and sets a display of the touch screen 280 on the body 110 based on the detected orientation. Similarly, the neck 175 may include an orientation detection/setting module which detects an orientation of the neck 175, and sets a display of the touch sensitive surface 285 on the neck 175. The orientation detection/setting module 114 may allow the music device 100 to be configured differently depending upon whether the music device 100 is being used by a right-handed user or a left-handed user. In particular, the orientation detection/setting module 114 may cause the touch sensitive surface 280 on the body 110 and the touch sensitive surface 285 on the neck 175 to be configured differently depending on whether the device 100 is being used by a left-handed user or a right-handed user. Further, changing from a left-handed user to a right-handed user may cause the device 100 to reconfigure (e.g., automatically reconfigure), without needing any user input.

FIG. 2C illustrates a music device 100 including a keyboard instrument input module 160d connected to the receiving part 150b, and a neck 175 connected to receiving part 150c and including a touch sensitive surface 285 which displays keys of a keyboard instrument.

FIG. 2D illustrates a music device 100 including a string instrument input module 160c connected to the receiving part 150b, and a neck 175 connected to receiving part 150c and including a touch sensitive surface 285 which displays keys of a keyboard instrument.

FIG. 2E illustrates a music device 100 including a string instrument input module 160c connected to the receiving part 150a, and a neck 175 connected to receiving part 150c and including a touch sensitive surface 285 which displays a trombone slide 286.

Alternatively, the string instrument input module 160c in FIG. 2E may be replaced with a touch sensitive surface 280. In this case, similar to the circuit 165 in the string instrument input module 160c illustrated in FIG. 1F, the touch sensitive surface 280 may also include a memory device which stores various programs and data, and a microcontroller which accesses the memory device to control the operations of the touch sensitive surface 280. In particular, the memory device may store a plurality of “string” configurations. Variations can include number of strings, gauge and spacing variations, analog or digital actuation identification of strings with exemplary embodiments of four (4) or more strings. Variations may include but are not limited to emulation of traditional instruments, including but not limited to mandolins, banjos, guitars and bass guitars and finger input based emulation of classical string instruments such as double bass, cello, harp or violin.

FIG. 3A illustrates a system 300 for making music, according to an exemplary aspect of the present invention.

As illustrated in FIG. 3, the system 300 includes a device (e.g., computer 394) for generating a programming signal, and a music device 350 which is programmable by the programming signal, for making music. The music device 350 includes a first input part for generating a first signal based on a user input, a music signal generator for generating a music signal based on the first signal, and a second input part for generating a second signal based on a user input, the second signal controlling the music signal generator, and the second input part including a plurality of first buttons which correspond to a range including at least one of a key, a note and a chord, and a plurality of second buttons which correspond to at least one of a note and a musical scale within the range.

The system 300 may also include a display device 360 which may display musical notation (e.g., indicia) corresponding to the plurality of first buttons of the first input part of the music device. The display device 360 may include a transceiver for communicating (e.g., wired or wirelessly communicating) with the music device 350. A user may read and follow a musical composition displayed on the display device 360 to play the device 350.

The system 300 may also include a display device 397 which may be worn by a user, such as a heads-up display device display device. The display device 397 may include, for example, a wireless transceiver which is wirelessly connected to the music device 100.

FIG. 3B illustrates an electrical circuit 365 which may be included in the music device 350 (e.g., and the music device 100), according to an exemplary aspect of the present invention. As illustrated in FIG. 3B, the circuit 365 may include a memory device 370 which may store programs and data such as personal information and musical compositions, and a microcontroller 371 (e.g., a programmable microcontroller) which may access the memory device 370 in order to control an operation of the music device 350. The circuit 365 may be electrically connected to the second input part 170, the music signal generator 130 and the output part 140. The microcontroller 371 may also be electrically connected to the receiving parts 150a, 150b and 150c (and, therefore, to the second input part), the power source 115, the selector 116, and the aural feature setting selector 117.

The microcontroller 371 may also be connected to the transceiver 118 so that the microcontroller 371 can control a communication between the music device 350 and external devices such as the other devices in the system 300.

Referring again to FIG. 3A, the system 300 may also include a foot pedal module 390 which includes a transceiver for communicating (e.g., wired or wirelessly communicating) with the music device 350. The module 390 may include an input portion 391 (e.g., foot pedal) which receives an input for wirelessly setting the music signal generated by the music signal generator 130. For example, the input portion 391 may generate an input signal that may alter the music signal to change the musical parameters (tonal or sounds) of keys, notes, chords, pitch or pitch class, scales and octaves of sounds generated by the output part 140 (e.g., sound generator) based on the music signal. In this case, the music signal generator 130 may generate the music signal based at least in part on the input signal from the module 390.

The system 300 may include a bow 392 (e.g., a hybrid bow) for playing the music device 350 when configured to include a string instrument input module 160c. The bow 392 may also include a transceiver for communicating (e.g., wired or wirelessly communicating) with the music device 350.

The system 300 may also include an external sound generator 393 which may, for example, include an amplifier for amplifying the music signal generated by the music signal generator 130. The external sound generator 393 may also include a transceiver for communicating (e.g., wired or wirelessly communicating) with the music device 350.

The system 300 may also include a computer 394 or a computer system (e.g., server) which is connected to a network (e.g., Internet). The computer 394 may be used, for example, to program the microcontroller 371 of the music device 350. Further, the music device 350 may access information such as music libraries online through the computer 394 (e.g., online music libraries), and store such information in the memory device 370. The computer 394 may also include a transceiver for communicating (e.g., wired or wirelessly communicating) with the music device 350.

The elements of the system 300 may represent an input, output, interface, control, operating system, processing, storage, memory, software, firmware, interconnect, standard and proprietary protocols, power supply and battery components, wired and wireless connections and updateable software and/or firmware and upgradeable capability system to not only emulate traditional musical instruments, systems and sounds, but also to allow for inputs and outputs not possible on conventional musical instruments. Achieving this capability requires the following elements:

The components of the system 300 include but not limited to fixed or removable input, output, interfaces, controls, operating system, processing, storage, memory, software, firmware, interconnects, standard and proprietary protocols, power supply and battery components, wired and wireless connections and updateable software and/or firmware and upgradeable capability.

It should be noted that the embodiments illustrated in FIGS. 1A-3B are only exemplary and should not be considered limiting the present invention.

In particular, the plurality of first buttons 135 in the second input part 170 in FIG. 1A may include, for example, twenty-four (21) buttons (e.g., input/output subdivisions). These subdivisions are completely programmable by the user. In another exemplary aspect, the first seven subdivisions of the second input part 170 (those nearest logo output part 140) are primary (tonic, key of tune for the music device 100) or secondary (key or major chord of sound or music being played by the music device 100) musical keys A through G inputs. The next two buttons (after the first seven buttons in a direction away from the output part 140) may be programmable for variations including, but not limited to, chords, pitch, and octave. The next twelve buttons may be programmed for the solo note play in the select key, chromatic scales or twelve octave semitones, and so.

Further, the neck 175 in FIG. 1E may include twelve buttons (e.g., input/output subdivisions). Twelve buttons may provide a user with all of the functionality of the twenty-one buttons in conjunction with three inputs, though the fewer buttons would reduce variations and most probably speed and dexterity of changes. Embodiments with less than twelve buttons are contemplated, but will have compromises in regards to inputs and outputs variations and playability.

Further, the foot pedal module 390 illustrated in FIG. 3A includes three pedals 391 (e.g., input/output switches), but the module 390 can include any number pedals 391. Further, the module 390 can control any of the parameters of the first and second input parts 160, 170, and may also add another user input (e.g., via a foot or feet) to the potential user (e.g., simultaneous) input variations.

The invention and its various input/output parts (e.g., first input part 160, second input part 170, foot pedal module 390) may enable the user to never play an incorrect musical sound or variation. The user may attain virtually perfect timbre. For example, if the user selects a C chord, it will always be a perfect C chord regardless of the time the user has dedicated to the invention, the placement within the C chord section, the force used by the user, the duration over which the user depresses the button (e.g., key, etc.), or the number of times the user has played a C chord.

If the user switches from a C chord to an Am7 and the input sequence is correct, it will also be a perfect Am7 chord. If the user moves to the solo note section, the twelve variations of the chromatic scale will be perfectly based on the key the user is currently playing. Even if the sequence or variation of notes, chords, etc. were not intended to be played by the user, each variation will be perfect tonally and musically.

Further, the components of the music device 100, 350 and the other components of the system 300 may be digital electronics components, and may include an operating system and supporting software for supporting the operating system. The invention contemplates both digital and analog input/output between the music device 100, 350 and other features of the system 300. Further, although not illustrated in FIG. 3A, the system 300 may include other devices and corresponding interconnections including, but not limited to, amplifiers, sound boards, digital and analog recording equipment, computer type keyboards, internet protocols, Bluetooth or other wireless protocols, personal digital assistants (PDAs), smart phones (e.g., iphones), other musical protocol devices (e.g., MIDI enabled devices), USB devices, Firewire, headphones, plug-in speaker output modules, solid state drive (SSD) storage devices and other music devices 100, 350.

For example, the transceiver 118 (e.g., wireless transceivers) in the music device 350 may allow for wireless communication between a plurality of music devices 100, 350. Thus, for example, user 1 may play a music device 100 and may coordinate his performance with user 2 which is playing a different music device 100. For example, user 1 and user 2 may coordinate rhythms, harmonies, chords, compositions, etc. on the music devices 100 via their respective transceivers 118.

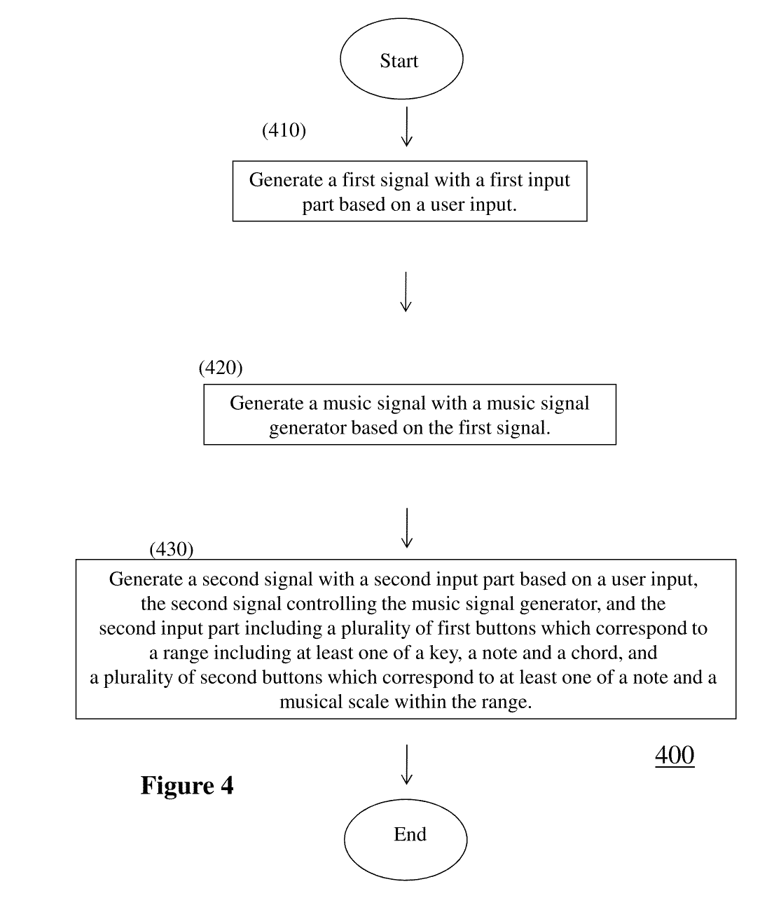

FIG. 4 illustrates a method 400 of making music, according to another exemplary aspect of the present invention. As illustrated in FIG. 4, the method 400 includes generating (410) a first signal with a first input part based on a user input, generating (420) a music signal with a music signal generator based on the first signal, and generating (430) a second signal with a second input part based upon a user input, the second signal controlling the music signal generator, and the second input part including a plurality of first buttons which correspond to a range including at least one of a key, a note and a chord, and a plurality of second buttons which correspond to at least one of a note and a musical scale within the range.

Another exemplary aspect of the present invention is directed to a user-selectable primarily left or right-handed operable neck (e.g., neck 175) including a connecting part (e.g., connecting part 191 in FIG. 1I, or connecting part 152 in FIG. 1D) for connecting to the body of the music device 100.

Another exemplary aspect of the present invention is directed to a user-selectable primarily left or right-handed operable input module (e.g., input modules 160a-160e), including a connecting part (e.g., connecting part 191 in FIG. 1I, or connecting part 152 in FIG. 1D) for connecting to the body of the music device 100.

Another exemplary aspect of the present invention is directed to an electronic logo, including a connector and compatibility verifiable part (e.g., connecting part 191 in FIG. 1I, or connecting part 152 in FIG. 1D), for connecting to the neck 175 of the music device 100.

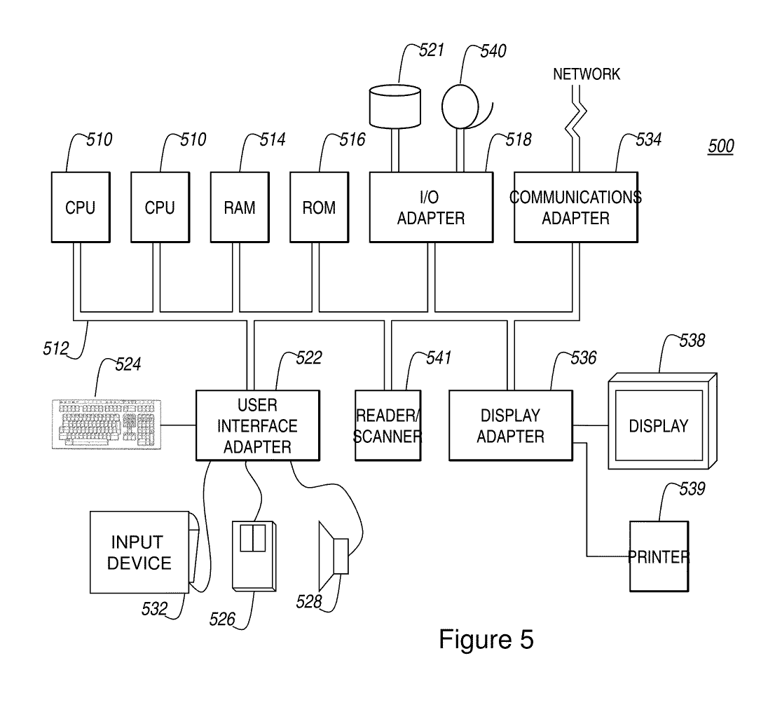

Referring now to FIG. 5, system 500 illustrates a typical hardware configuration which may be used for implementing the method of the present invention (e.g., music device 100, music device 350, system 300 and method 400). The configuration has preferably at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 528, speaker 528, microphone 532, pointing stick 527 and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer 539. Further, an automated reader/scanner 541 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of non-transitory signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 511 to execute a sequence of machine-readable instructions. These instructions may reside in various types of signal bearing media.

Thus, this aspect of the present invention is directed to a programmed product, including a non-transitory signal-bearing media tangibly embodying a program of machine-readable instructions executable by a digital data processor incorporating the CPU 511 and hardware above, to perform the method of the invention.

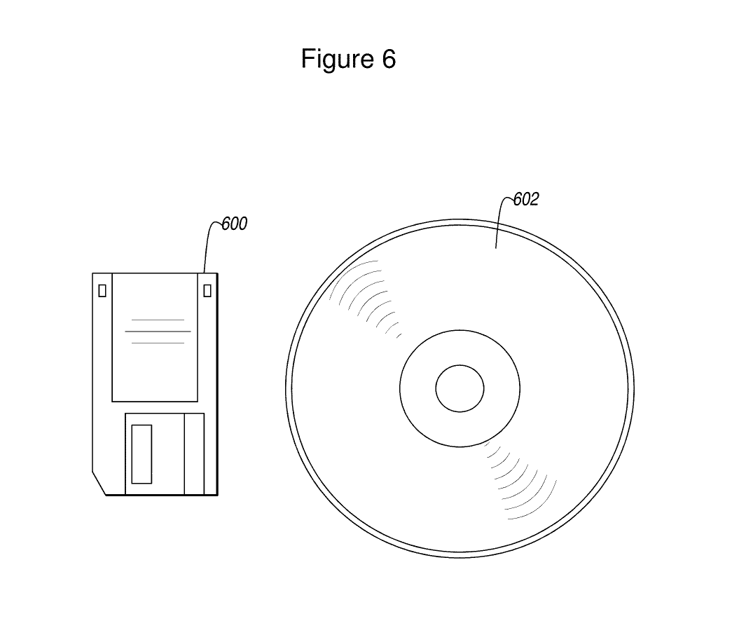

This signal-bearing media may include, for example, a RAM contained within the CPU 511, as represented by the fast-access storage for example. Alternatively, the instructions may be contained in another signal-bearing media, such as a magnetic data storage diskette 600 or compact disc 602 (FIG. 6), directly or indirectly accessible by the CPU 511.

Whether contained in the computer server/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable non-transitory signal-bearing media. In an illustrative embodiment of the invention, the machine-readable instructions may include software object code, compiled from a language such as C, C++, etc.

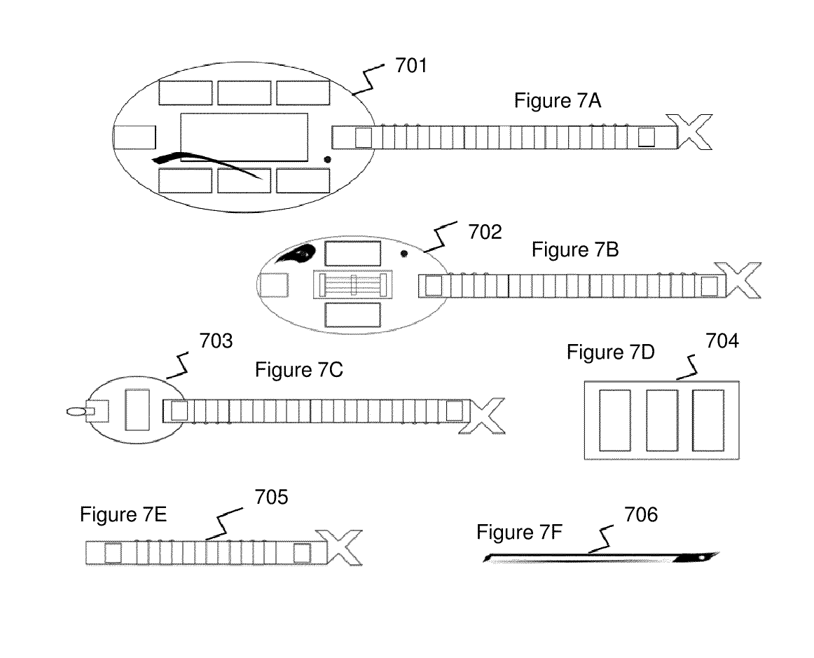

FIGS. 7A-22F illustrate a music device according to another exemplary aspect of the present invention.

Due to its design, attributes and methodologies, the hybrid instrument according to the exemplary aspects of the present invention may be more ergonomically designed, less physically demanding and more easily played by individuals with a larger variation of human hand sizes, finger strengths, arm lengths, breath capacities and physical characteristics.

The hybrid instrument according to the exemplary aspects of the present invention may also facilitate easier learning, playing, composing and performing of music than traditional musical instruments, which may allow for more future musicians and composers of wider ages, physical variations and experience levels.

The exemplary aspects of the present invention may completely eliminate playing the selected chord, note, pitch or other variation improperly. The exemplary aspects of the present invention may allow musicians and composers to easily and in much shorter timeframes become proficient on the hybrid instrument of the exemplary aspects of the present invention, thus freeing the user of the present hybrid musical instrument to focus on creating, composing, playing, performing, and/or sharing music.

In an exemplary aspect, the present invention includes a new system for making music, and more specifically, changing the musical parameters (tonal or sounds) of keys, notes, chords, pitch or pitch class, scales and octaves.

In an exemplary embodiment, the present invention includes a series of electronic, microprocessor or “machine intelligent” hybrid analog and or digital musical instruments in the traditional categories of bowed strings, woodwinds, brass, keyboard and guitar instruments.

The present invention may use different combinations or variations of input components, keys, switches, buttons, strings or touch sensitive zones to change musical parameters of (musical or tonal) keys, notes, chords, pitch or pitch class, scales and octaves on a fixed or removable neck. The exemplary aspects of the present invention may emulate the traditional musical instrument categories of bowed strings, woodwind, brass, keyboard and guitar.

The exemplary features of the present invention may also allow for variations not possible by traditional instruments or current synthesized instruments.

In one exemplary embodiment, the hybrid musical instruments have a main body which includes different input and output sections, fixed or optional switchable string, “piano” key, mouthpiece input or touch sensitive pad or touch sensitive bar modules with various switchable modules and/or “necks” to create an entirely new class of musical instruments.

Further, the exemplary aspects of the present invention can be manufactured as a single unit or in modules to be configured by the user of the exemplary aspects of the present invention as a primarily left-handed or right-handed instrument.

For example, the body of the hybrid instrument according to the exemplary aspects of the present invention includes the core electronics, processing and interface modules. The exemplary aspects of the present invention may use various input and output interfaces for musicians.

Additionally, the exemplary aspects of the present invention may include a common methodology for producing, changing and terminating tonal keys, notes, octaves, pitches or tonal key, note or any sound variations and parameters. Thus, with the exemplary aspects of the present invention, a musician (or beginner) may be able to learn these different instruments more easily and faster by virtue of the methodologies and commonality between the instruments.

Additionally, the exemplary aspects of the present invention may be able to output both digital and/or analog signals, allowing for different output interfaces to various devices including amplifiers, computers, recording equipment and any device that can accept the specific analog or digital outputs of the exemplary aspects of the present invention.

Referring now to the exemplary aspects of the present invention in more detail, in FIG. 7A there is shown a “guitar/keyboard” type hybrid musical instrument version of the finger 701, in FIG. 7B, there is shown a “bowing” type bow hybrid musical instrument version of the bow 702, in FIG. 7C there is shown a “blowing” type wind hybrid musical instrument version of the wind 703, in FIG. 7D, there is shown a foot pedal 704 interface for finger 701, bow 702 and wind 703 of the exemplary aspects of the present invention, in FIG. 7E there is shown a neck 705 (e.g., an alternative number of inputs “neck” configuration) for invention hybrid musical instruments finger 701, bow 702 and wind 703; and in FIG. 7F there is show a specific hybrid bow, xbow 706 which may be used with an bow 702

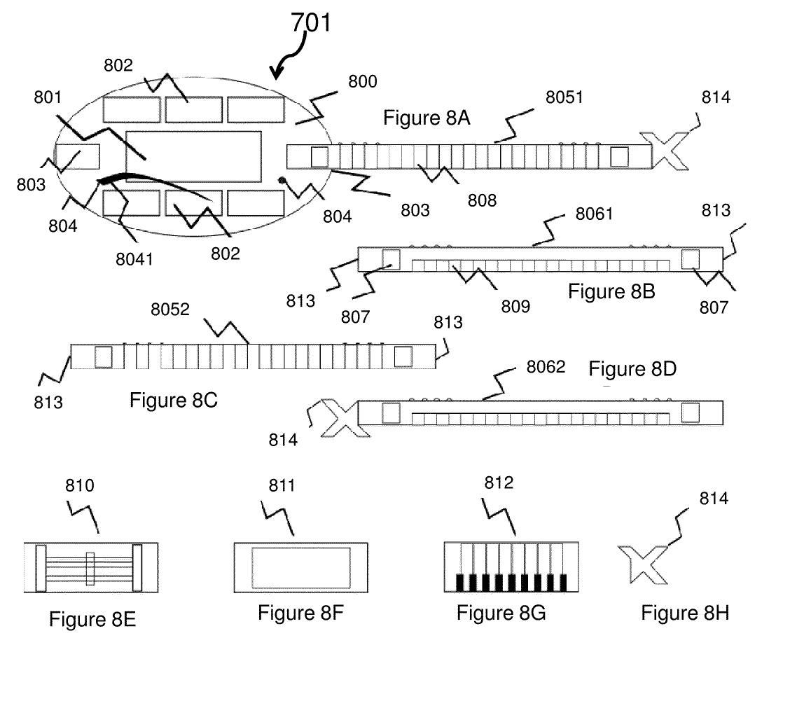

In FIG. 7A, and FIGS. 8A to FIG. 11, there are shown the main elements of finger instrument 701. The finger instrument 701 has input and output elements.

In FIGS. 8A and 8E-8G, there are shown sections body 800, first input/output zone 801 and corresponding modules strings 810, touch pad 811 or keys 812, input/output zones and corresponding modules 802, first removable neck connection zones CZ 803 and corresponding input/output zone two, I/O Two necks, and neck 8051 (FIG. 8A) which is a right-handed mode touch sensitive neck 8051.

Also provided are a neck 8052 (FIG. 8C) which is a left-handed mode touch-sensitive neck 8052, neck 8061 (FIG. 8B) which is a right-handed mode switch neck 8061 or neck 8062 which is a left-handed mode switch neck 8062 (FIG. 8D), fourth input/output zone and corresponding modules 807, first “fret emulators” or touch- and pressure-sensitive neck input output subdivisions NIS 808, switches, second keys or buttons neck input output subdivisions NIS 809, second handle connection zones CZ 804 and corresponding handle 8041, third logo connection zone CZ 813 and fixed or detachable, interchangeable, electronic or non-electronic, electrifiable (for lighting or other electrified applications), personalized-identifier, standard or customizable logos or shapes , logo 814 (FIG. 8H).

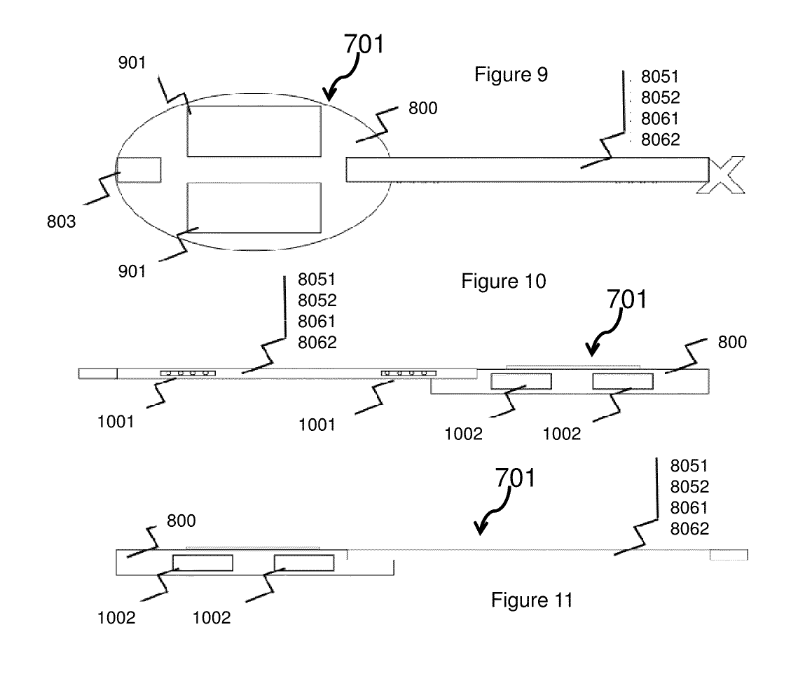

In FIG. 9, there is shown the backside of finger 701, in which access panel 901 represents removable panels for access to body 800 internal electronics, boards, systems and peripherals, neck connection zone 803 and neck designations 8051, 8052, 8061 and 8062 are shown for reference.

In FIG. 10, there is shown a first side view of finger 701's third input/output zone and corresponding modules 1001, input/output zone six and corresponding modules 1002, body 800 and neck designations 8051, 8052, 8061 and 8062 are also shown for reference.

In FIG. 11 there is shown another side view of finger 701, body 800, I/O Five 1002 and neck designations 8051, 8052, 8061 and 8062 are also shown for reference.

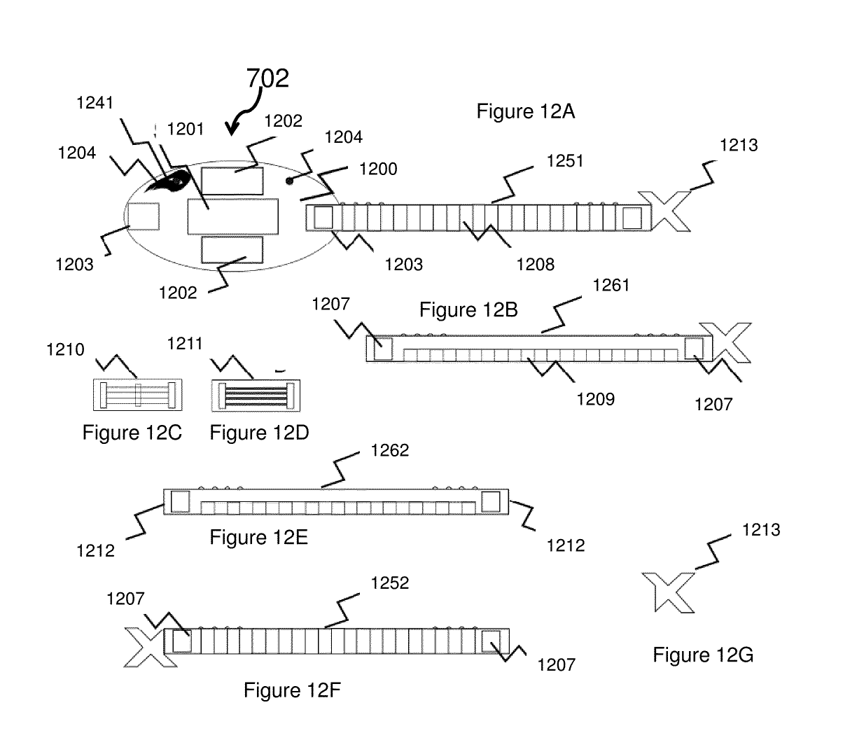

Referring to FIGS. 12A to FIG. 16, there are shown the main elements of bow instrument 702 shown in FIG. 1B.

The instrument bow 702 has input and output elements. In FIG. 12A, there are shown sections of body 1200, including an input/output zone (I/O) 1201 and corresponding modules strings 1210 (FIG. 12C) or touch bars 1211 (FIG. 12D), input/output zones and corresponding modules (I/O) 1202, removable neck connection zones CZ 1203 and corresponding two input/output zone I/O necks, including a neck 1251 which is a right -handed mode touch sensitive neck 1251, and a neck 1252 which is a left-handed mode touch sensitive neck 1252 (FIG. 12F).

Also shown are a neck 1261 which is a right-handed mode switch neck 1261 (FIG. 12B) or neck 1262 (FIG. 12E) which is a left-handed mode switch neck 1262, input/output zone and corresponding modules I/O 1207, “fret emulators” or touch and pressure sensitive neck input subdivisions NIS 1208, switches, keys or buttons neck input subdivisions NIS 1209, two handle connection zones CZ 1204 and corresponding chin rest 1241, logo connection zone CZ 1212 and fixed or detachable, interchangeable, electronic or non-electronic, electrifiable (for lighting or other electrified applications), personalized-identifier, standard or customizable logos or shapes 1213 in FIG. 12G.

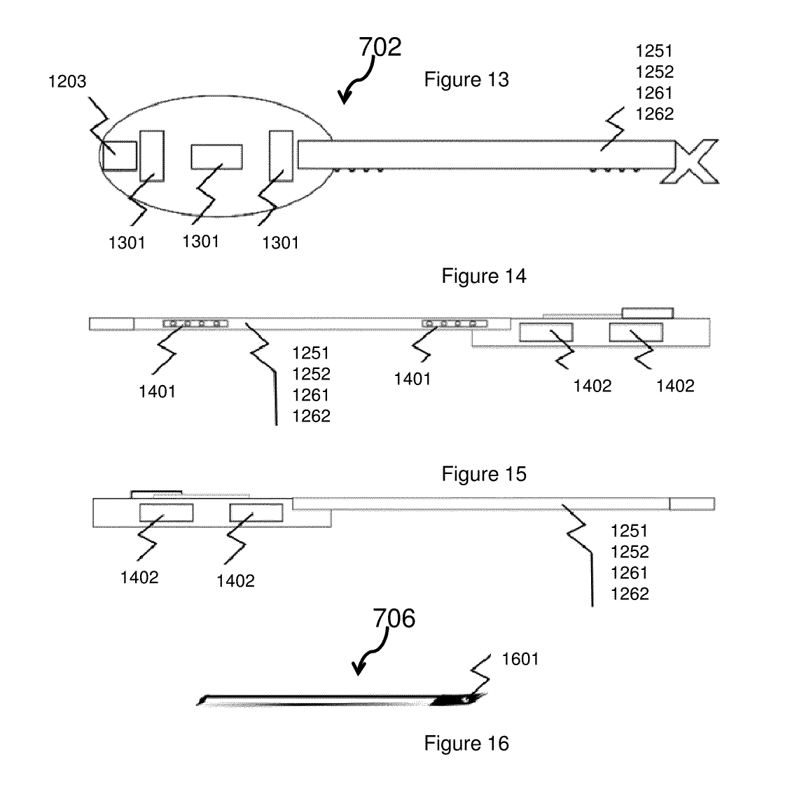

In FIG. 13, there are shown the backside of bow 702, in which access panel 1301 represents removable panels for access to body 1200 internal electronics, boards, systems and peripherals, neck connection zone 1203 and neck designations 1251, 1252, 1261 and 1262 are shown for reference.

In FIG. 14, there are shown a side view of bow 702 input/output zone and corresponding modules I/O 1401, input/output zone and corresponding modules 1402, body 1200 and neck designations 1251, 1252, 1261, and 1262 are also shown for reference.

In FIG. 15, there are shown another side view of bow 702, in which body 1200, I/O 1402 and neck designations 1251, 1252, 1261, and 1262 are also shown for reference.

In FIG. 16, there are shown a side view of a specific bow xbow 706 for bow 702 optional input and output module capabilities are anticipated string bow input/output zone I/O 1601 for bow 702.

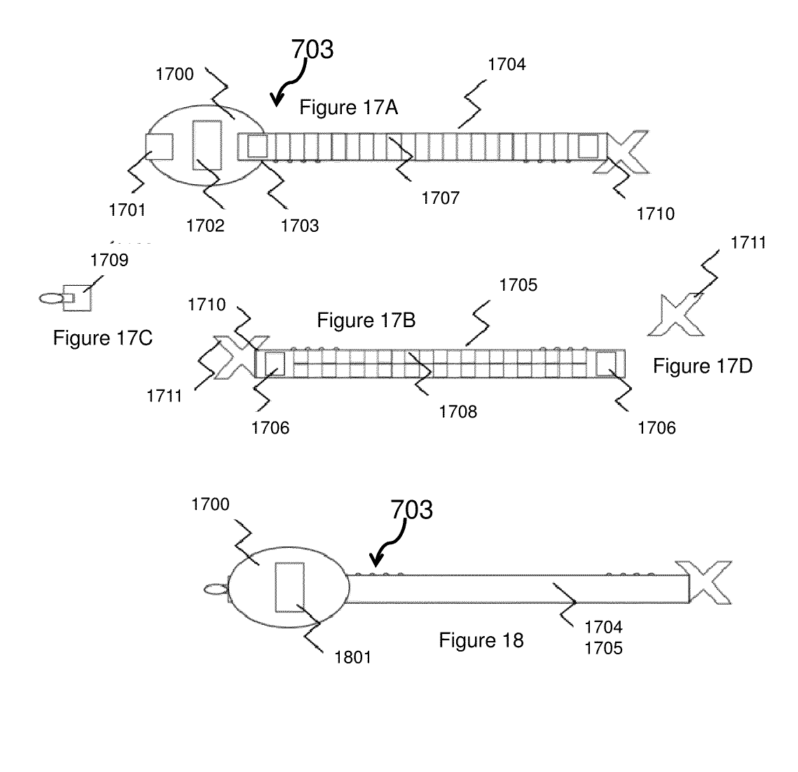

Referring to wind 703, in FIG. 17A to FIG. 21, there are shown the main elements of wind instrument 703. The instrument wind 103 has input and output elements.

In FIG. 17A, there are shown sections of body 1700, including input/output zone I/O 1701 and corresponding module mouthpiece 1709 (FIG. 17C), input/output zone and corresponding modules I/O 1702, removable neck connection zones CZ 1703 and corresponding input/output zone I/O necks, which include neck 1704 shown in left-handed mode touch sensitive neck 1704, and neck 1705 shown in right-handed mode paired switches neck 1705, input/output zone and corresponding modules I/O 1706, “fret emulators” or touch and pressure sensitive neck input subdivision pairs MS 1707, switches, keys, buttons or touch pads neck input subdivision pairs NIS 1708, logo connection zone CZ 1710 and fixed or detachable, interchangeable, electronic or non-electronic, electrifiable (for lighting or other electrified applications), personalized-identifier, standard or customizable logos or shapes, 1711 in FIG. 17D.

In FIG. 18, there are shown the backside of wind 703, access panel 1801 represents removable panels for access to body 1700 internal electronics, boards, systems and peripherals, neck designations 1704 or 1705 are shown for reference.

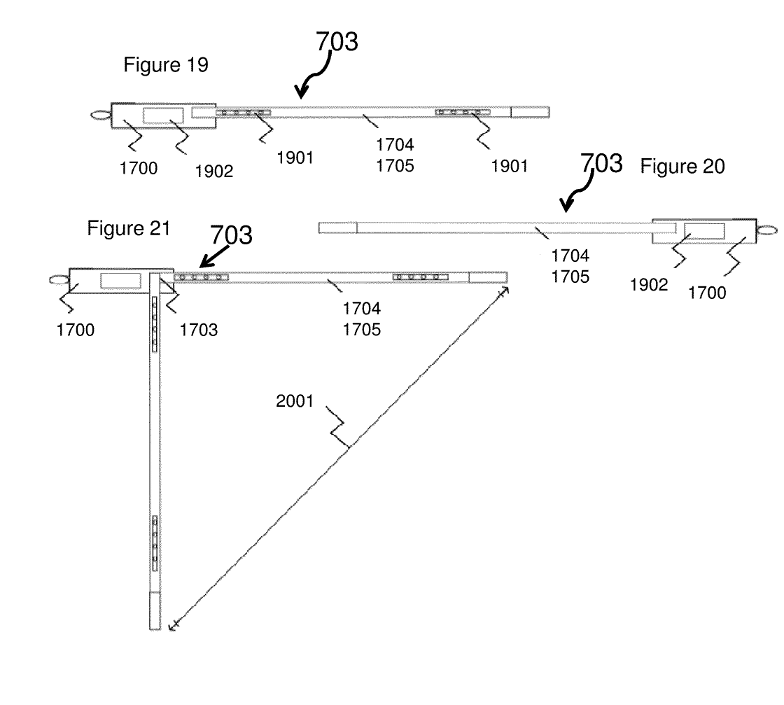

In FIG. 19, there are shown a side view of wind 703 including input/output zone and corresponding modules I/O 1901, input/output zone and corresponding module(s) I/O 1902, body 1700 and neck designations 1704 or 1705 are shown for reference.

In FIG. 20, there are shown another side view of wind 703, body 1700 and neck designations 1704 or 1705 and modules I/O 1902 are shown for reference.

In FIG. 21, which shows another side view of wind 703, the neck 1704 or 1705 can articulate or rotate up to ninety degrees (90°) down toward a user (i.e., a degree of rotation is shown at reference number 2001), with body 1700 being shown for reference.

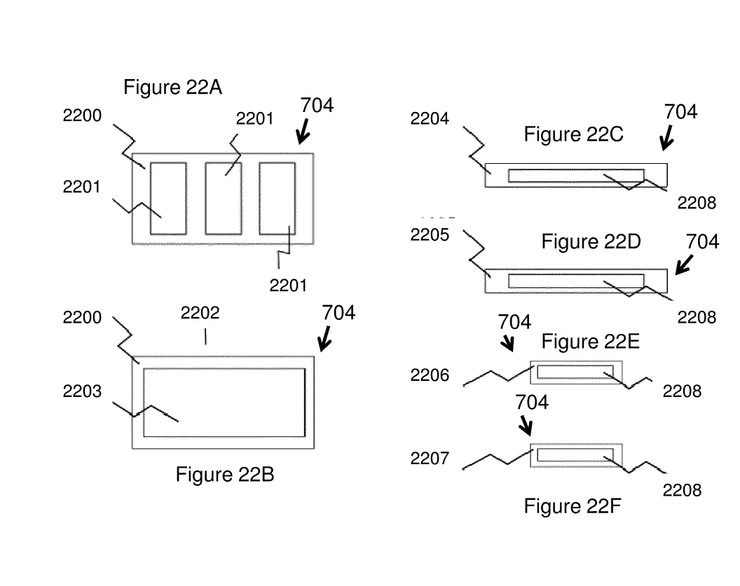

In FIG. 22A, there is shown a peripheral input/output device designated zone I/O pedal 704 for use with finger 701, bow 702 or wind 703, in which electronics and other functions and systems are housed in the body 2200, one or more zones and corresponding buttons, switches, keys, modules or other input methods or output devices are designated switch 2201.

In 2202 (seed FIG. 22B), there is shown the bottom side of body 2200. A removable panel 2203 for access to the pedal internals is shown in panel 2202.

In FIGS. 22C-22F, respectively, there are shown four side views of pedal 704 including a first side view of side 2204, a second side view of side 2205, a third side view of side 2206, and a fourth side view of side 2207. Each side 2204, 2205, 2206, 2207 may have an input output module I/O 2208.

In more detail, the invention of finger 701, bow 702 and wind 703, and pedal 704, may include a system of inputs and outputs to change musical parameters (tonal or sounds). The finger 701, bow 702, wind 703 and pedal 704 represent an input, output, interface, control, operating system, processing, storage, memory, software, firmware, interconnect, standard and proprietary protocols, power supply and battery components, wired and wireless connections and updateable software and/or firmware and upgradeable capability system to not only emulate traditional musical instruments, systems and sounds, but also to allow for inputs and outputs not possible on conventional musical instruments. Achieving this capability may require the following elements:

In FIG. 7A-7F, the finger 701, bow 702, wind 703 and pedal 704, have common elements that may encompass a system according to an exemplary aspect of the present invention.

FIGS. 8A-8H, 12A-12G, 17A-17D and 22A-22F show body 800, 1200, 1700 and 2200, respectively, which may be designed to house the main system components of the invention finger 701, bow 702, wind 703 and pedal 704.

The system's components may include but are not limited to fixed or removable input, output, interfaces, controls, operating system, processing, storage, memory, software, firmware, interconnects, standard and proprietary protocols, power supply and battery components, wired and wireless connections and updateable software and/or firmware and upgradeable capability. The finger 701, bow 702, and wind 703 when manufactured as a system comprised of components detailed in the figures and descriptions of FIG. 8A to FIG. 21 of the invention is manufactured with all components configured as symmetrical for user configuration and assembly in either left or right-hand use.

In FIG. 7A-7F, the finger 701, bow 702, wind 703 and pedal 704 inputs and outputs include input output zone I/O 801, 1201, and 1701, respectively, and input/output zone I/O 2201 (FIG. 22A-22F). These sections utilize strings 810, touch pad 811, keys 812 designated as primary input methodology utilizing fingers for I/O 801, I/O 1201, strings 1210, touch bars 1211 designated as primary input methodology utilizing a specific bow in FIG. 16 for I/O 1201, mouthpiece 1709 designated as primary input methodology utilizing mouth or blowing for I/O 1701, and I/O 2201 designated as primary input methodology utilizing a foot or feet.

When designed as removable modules strings 810, touch pad 811, keys 812, strings 1210, touch bars 1211 and mouthpiece 1709 have systems or intelligence imbedded within the module that allow systems within body 800, 1200 and 1700 to recognize multiple parameters of the modules including but not limited to left or right-handed designation and type of conventional instrument emulation.

The face or top of body 800, 1200, 1700 and 2200 also includes input/output zones 802, 1202, 1702 and 2201, respectively, which can have dedicated or programmable inputs or outputs. Many embodiments directed to functionality, size, number of inputs or outputs, etc. are contemplated and the I/O Zones 802, 1202, 1702, and 2201 are designated as primary input methodology utilizing fingers.

The face of body 800 and 1200 also includes a connection zone CZ 804 and 1204, respectively, used for input and output functions in conjunction with handle 8041 or chin rest 1241.

The back of body 800, 1200, 1700 and 2200, (e.g., see FIGS. 9, 13, 18 and 22) includes the ability to access the embedded and removable systems and components panel 901, 1301, 1801 and 2201, respectively, within body 800, 1200, 1700 and 2200 shown in FIGS. 8, 12, 17, and 22.

In FIGS. 8A-8H, 12A-12G, 17A-17D and 22A-22F, there are shown sides of body 800, 1200, 1700 and 2200, respectively. In FIGS. 10, 11, 14, 15, 19, 22 and 22C-22F, there are shown input/output zones 1002, 1402, 1902 and 2208, respectively, which may have dedicated or programmable inputs or outputs. Many embodiments directed to functionality, size, number of inputs or outputs, etc. are contemplated and the input/output zones 1002, 1402, 1902 and 2208 are designated as primary input methodology utilizing fingers.

There is shown connect zones CZ 804 and 1204 on the face of body 800 and 1200, respectively. The connection zones may have the primary task of providing an input for pitch bending when handle 8041 is designated as primary input methodology utilizing hands and fingers on finger 701 or chin rest 1241 is designated as primary input methodology utilizing chin, cheek or jaw, on bow 702. The connection zones can take on additional functionality with a series of anticipated input and output modules.

In FIG. 21, there is shown for wind 703, body 1700, at CZ 1703, neck 1704 and 1705, the ability to articulate or cantilever up to ninety-degrees (90°) downward toward the user, and/or rotate 2001 for easy customization of a user's choice of neck position 1704 or 1705.

In FIGS. 8A-8H, 12A-12G, and 17A-17D, as I/O necks, neck 8051, 8052, 8061 and 8062; 1251, 1252, 1261 and 1262; 1704 and 1705, respectively, are designated as corresponding to connection zones CZ 803 for finger 701, CZ 1203 for bow 702, CZ 1703 for wind 703. I/O necks are designated as primary input methodology utilizing fingers.

When designed and designated as removable I/O necks, neck 8051, 8052, 8061 and 8062; 1251, 1252, 1261 and 1262; 1704 and 1705 have systems or intelligence embedded within the neck that allow systems within body 800, 1200 and 1700 to recognize multiple parameters of the modules including, but not limited to, left or right-handed designation, types of conventional instrument emulation, electrification or non-electrification, lighted or non-lighted, types of conventional instrument emulation, types of I/O neck input system (NIS), first NIS 808, 1208 and 1707; second NIS 809, 1209 and 1708, the programming interface protocol for input/output zones 807, 1207, 1706.

When designed and designated as non-removable I/O necks, neck 8051, 8052, 8061 and 8062; 1251, 1252, 1261 and 1262; 1704 and 1705 may or may not have the same functions, systems and components embedded within neck 8051, 8052, 8061 and 8062; 1251, 1252, 1261 and 1262; 1704 and 1705.

In FIGS. 10, 14 and 19, the programming interface protocol for third input/output zones 1001, 1401 and 1901 can have dedicated or programmable, fixed or removable inputs or outputs. Many embodiments of functionality, size, numbers of inputs or outputs etc. are contemplated and the third I/O 1001, 1401 and 1901 sections are designated as primary input methodology utilizing fingers. In FIGS. 8A-8H, 12A-12G, and 17A-17D, there are shown second I/O necks, including neck 8051, 8052, 8061 and 8062; 1251, 1252, 1261 and 1262; and 1704 and 1705. The referenced necks can be designated and manufactured as fixed to body 800, 1200 and 1700 or as a removable module. There is shown a connection interface for a logo, including logo 813, 1213 or 1710, or input output functions including but not limited to programming, left or right-handed designation, type of conventional instrument emulation, electrification or non-electrification, type of conventional instrument emulation at the end away from body 800, or 1700 and connection zone CZ One 803, 1203 or 1703, in the case of a fixed neck or both ends of removable necks, neck 8051, 8052, 8061 and 8062; 1251, 1252, 1261 and 1262; 1704 and 1705. The end that takes on the functionality shown in logo 813, 1213 or 1703 is the end not connected or to be connected into first CZ 803, 1203 or 1703.

Still referring to the invention in more detail FIGS. 7A to 22F, the systems, methodologies and techniques to create music or sounds are unique to the exemplary aspects of the present invention. The finger 701, bow 702 and wind 703 (i.e., see FIGS. 7A-7C) maintain differentials and uniqueness in the input/output section one.

In strings 810 shown in FIG. 8A, a “string-based” module is shown for placement in first I/O 801 and anticipates various “string” configurations. Variations can include number of strings, gauge and spacing variations, analog or digital actuation identification of strings with preferred embodiments from 4 or more strings. Variations may include but are not limited to emulation of traditional instruments, including but not limited to mandolins, banjos, guitars and bass guitars and finger input based emulation of classical string instruments such as double bass, cello, harp or violin.

Touch pad 811 is a programmable “touch-sensitive” pad that can be programmed by the user for various input play modes. Keys 812 shows a “piano” type key configuration, and embodies a traditional “piano” key layout or as shown in keys 812 a finger 701 invention specific “piano” type key layout.

Strings 810, touch pad 811, keys 812 and other future embodiment modules may have embedded processing or intelligence electronics that interface with first I/O 801 to identify type of input module, type of instruments to be emulated, left-handed or right-handed mode selection and other future contemplated variations.

In FIGS. 12A-12F, strings 1210 are shown including a “string-based” module for placement in first I/O 1201 and anticipates various “string” configurations. Variations can include number of strings, gauge and spacing variations analog or digital actuation identification of strings with preferred embodiments from 4 or more strings. Variations include, but are not limited to, emulation of traditional instruments, including but not limited to violin, fiddle, viola, cello, double bass, etc.

Touch bars 1211 are programmable “touch-sensitive” bars that can be programmed by the user for various input play modes. Strings 1210, touch bars 1211 and other future embodiment modules may have embedded processing or intelligence electronics that interface with first I/O 1201 to identify type of input module, type of instruments to be emulated, left-handed or right-handed mode selection and other future contemplated variations.

In FIGS. 17A-17D, a mouthpiece 1709 is shown for a wind module for placement in first I/O 1701 and anticipates various wind configurations. Variations can include type of wind instrument emulation of traditional instruments, including but not limited to French horn, trumpet, trombone and tuba, bassoon, clarinet, flute, oboe and saxophone, harmonica, etc. Mouthpiece 1709 and other future embodiment modules may have embedded processing or intelligence electronics that interface with first I/O 1201 to identify type of input module, type of instruments to be emulated and other future contemplated variations.

In FIG. 8A-8I, strings 810, touch pad 811 and keys 812, in FIGS. 12A-12G strings 1210 and touch bars 1211 and in FIGS. 17A-17D, mouthpiece 1709, the first Input/output section of the invention has the most similarity to conventional instruments in its methodologies and parameters of input for creating sound variations.

FIGS. 8A-8I, 12A-12G and 17A-17D fingers 810, touch pad 811 and keys 812, strings 1210, touch bars 1211 and mouthpiece 1709 are shown as first I/O inputs used to control sound creation parameters of input including, but not limited to, loudness, duration, location variation, velocity, pressure, rhythm, strumming-keyboarding-bowing-blowing patterns, pitch bending, vibrato, tremolo, deadening, plucking, slapping and buzzing, etc..

The second input/output section of the invention encompasses (see FIGS. 2A-2I, 6A-6H and 11A-11D), necks including neck 2051, 2052, 2061 and 2062; 6051, 6052, 6061 and 6062; and 1104 and 1105. The methodology for changes to sound parameters in this section is radically different than any conventional or synthesized conventional instrument.

Unlike conventional instruments, input/output methodology system of the second I/O section of the invention of FIGS. 7A-7B's finger 701 and bow 702 may be virtually identical. FIG. 7C's wind 703, by virtue of the first input zone of wind 703 using a mouthpiece 1709, has the same input/output system methodology as finger 701 and bow 702, but allows for using both hands on the FIG. 17A-17D's neck 1704 and 1705, thereby allowing two symmetrical sets of MS 1707 and 1708 (right- and left-hand), on neck 1704 and 1705.

The methodology system parameters are exemplary embodiments and thus other embodiments are contemplated. The parameters of sound or music can be changed by second input/output section necks of FIG. 8A-8I, 12A-12G and 17A-17D including neck 8051, 8052, 8061 and 8062; 8051, 8052, 8061 and 8062; and 1704 and 1705 which also includes first sections NIS 808, 1208 and 1707, second NIS 809, 1209 and 1708, four I/O 807, 1207 and 1706 and FIGS. 10, 14 and 19 third I/Os 1001, 1401 and 1901.

The parameters may include but are not limited to, musical key A thru G (including harmonic center or tonic), chords (including major, minor, sharp, flat, diminished, augmented, slash, power, dominant), pitch (including harmonics, frequency), octave (twelve semitones), scales (including chromatic, whole tone, pentatonic, diminished, diatonic, accidentals), notes, effects (including accent, sustain, distortion, dynamics, filters, modulation, time-based, reverb, feedback). The partial list of parameters can be executed with variations beyond any conventional instrument based on the user's ability to change virtually all sound parameters in real-time as fast as the correct input sequence can be made by the user.

In FIGS. 8A-8I, 12A-12G and 17A-17D, there is shown a system for changing the parameter(s) outlined previously in the second input/output section, including first MS 808, 1208 and 1707 and second MS 809, 1209, and 1708. The drawings show an exemplary embodiment of twenty-one input output subdivisions. These subdivisions are completely programmable by the user.

However, an exemplary version program is the first seven subdivisions (those nearest logo 814, 1213 and 1711) which are primary (tonic, key of instrument's tune) or secondary (key or major chord of sound or music being played) musical keys A through G inputs.

The next two input output subdivisions in conjunction with third I/O 1001, 1401 and 1901, are programmable for variations including, but not limited to, chords, pitch, and octave.

The next twelve input output subdivisions are programmed for the solo note play in the select key, chromatic scales or twelve octave semitones.

In FIG. 7E, there is shown a neck 705 which is a minimum exemplary embodiment. There is shown in neck 705, twelve input/output subdivisions. Twelve input/output subdivisions may provide a user with all of the functionality of the twenty-one input/output subdivisions, in conjunction with three I/O 1001, 1401 and 1901 inputs, though the fewer input/output subdivisions would reduce variations and most probably speed and dexterity of changes. Embodiments with less than twelve input output subdivisions are contemplated, but will have compromises in regards to inputs and outputs variations and playability.

In FIG. 7D, there is shown a pedal 704, which is the third input/output section of the invention. The exemplary embodiment of pedal 704 shows three separate programmable input/output switches shown in greater detail in FIG. 22A as I/O switches 2201. The third Input/output section can control any of the parameters of the first and second input/output sections, but adds another user input (a foot or feet) to the potential user simultaneous input variations.

The invention and its three input/output zones enable the user to never play an incorrect musical sound or variation. The user attains virtual perfect timbre or the user may choose to select off timbre variations as they choose for musical variations.

For example, if the user selects a C chord, it will always be a perfect C chord regardless of the time the user has dedicated to the invention, placement within the C chord section, the force used, the duration time, or the number of times the user has played a C chord. If the user switches from a C chord to an Am7 and the input sequence is correct, it will also be a perfect Am7 chord. If the user moves to the solo note section, the twelve variations of the chromatic scale will be perfectly based on the key the user is current playing. The user may not like the sequence or variations chosen, but with the exemplary aspects of the present invention, each variation will be perfect tonally and musically.

In FIGS. 7A-7D and 7F, there are shown finger 701, bow 702, wind 703, pedal 704 and xbow bow 706, which are digital electronics based, with an operating system and supporting software. The invention contemplates both digital and analog outputs of the invention to other devices and corresponding interconnections including, but not limited to, amplifiers, sound boards, digital and analog recording equipment, computers, computer type keyboards, internet protocols, Bluetooth or other wireless protocols, PDA's, smart phones, other musical protocol devices (such as MIDI enabled devices), USB devices, Firewire, headphones, invention specific plug-in speaker output modules, SSD storage devices and other finger 701, bow 702, wind 703 and pedal 704 and xbow 706.

In further detail, still referring to the invention of finger 701, bow 702, wind 703, pedal 704 and xbow 706 shown in FIGS. 7A-22F, the dimensions, shapes, materials and variations are virtually infinite. The invention and inventors contemplate that level of variation. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described exemplary embodiment, method, and examples, but by all embodiments and methods within the scope and spirit of the invention.

In summary, the exemplary aspects of the present invention may provide an electronic hybrid or completely digital musical instruments and a system for producing, changing and terminating tonal keys, notes, chords, scales, pitch, octaves and sound variations.

With its unique and novel features, the present invention provides a music device which may allow musicians and composers to become proficient at playing music in much less time than with conventional musical instruments.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A music device for making music, comprising:
a first input part for generating a first signal based on a user input;
a music signal generator for generating a music signal based on the first signal; and
a second input part for generating a second signal based on a user input, the second signal controlling the music signal generator, and the second input part comprising a plurality of first buttons which correspond to a range comprising at least one of a key, a note and a chord, and a plurality of second buttons which correspond to at least one of a note and a musical scale within the range.

2. The music device of claim 1, wherein the second input part further comprises:
a plurality of third buttons for defining a variation of the range or musical variables of the plurality of first buttons; and
a plurality of fourth buttons comprising a programmable function for varying at least one of chord, pitch and octave or other frequency, tonal or musical variables.

3. The music device of claim 1, wherein the second input part comprises an aural feature setting selector, for selecting an aural feature setting for the second input part, from among a plurality of aural feature settings, the aural feature setting selector comprising a selector for selecting at least one of a array of musical parameters or variables.

4. The music device of claim 1, further comprising:
a selector for selecting the music signal to correspond to one of a string instrument, woodwind instrument, brass instrument and keyboard instrument.

5. The music device of claim 1, further comprising:
a body, the music signal generator being formed in the body.

6. The music device of claim 5, further comprising:
an output part for outputting the music signal,
wherein the output part comprises a sound generator for generating a sound corresponding to one of a string instrument, woodwind instrument, brass instrument and keyboard instrument, based on the music signal.

7. The music device of claim 5, further comprising:
a programmable, electrifiable neck connected to the body,
wherein the body further comprises a symmetrical receiving part for receiving the neck, and the neck comprises a connector for detachably connecting the neck to the receiving part and based on which receiving part of body the neck is attached to allows the user to select primarily left or right-handed operation..

8. The music device of claim 7, wherein the neck is rotatably connected to the body.

9. The music device of claim 7, wherein the second input part is formed on at least one of the body and the neck.

10. The music device of claim 7, wherein the first input part is formed on the body and the second input part is formed on the neck.

11. The music device of claim 10, wherein the body further comprises a symmetrical receiving part for receiving the first input part, and the first input part comprises a connector for detachably connecting the first input part to the receiving part, and based on which receiving part of body the first input part is attached to allows the user to select primarily left or right-handed operation, and
wherein the first input part comprises at least one of:
a first input module comprising a structural element corresponding to one of a string instrument, woodwind instrument, brass instrument and keyboard instrument; and
a first touch sensitive surface, which displays a structural element corresponding to one of a string instrument, woodwind instrument, brass instrument and keyboard instrument.

12. The music device of claim 11, wherein the first input module comprises a string instrument input module comprising:
a plurality of strings;
a sensor for sensing a vibration or an analog or digital pickup for sensing a vibration of the plurality of strings and generating an electrical current representative of the vibration; and
a processing circuit for processing the current into the first input signal.

13. The music device of claim 11, wherein the first input module comprises a brass instrument input module comprising:
a brass instrument type mouthpiece;
a transducer, strain gage or other sensing component for sensing a pressure in the mouthpiece and generating an electrical current representative of the pressure; and
a processing circuit for processing the current into the first input signal.

14. The music device of claim 11, wherein the first input module comprises a woodwind instrument input module comprising:
a woodwind instrument mouthpiece;
a transducer, strain gage or other sensing component for sensing a pressure in the mouthpiece and generating an electrical current representative of the pressure; and
a processing circuit for processing the current into the first input signal.

15. The music device of claim 11, wherein the first input module comprises a keyboard instrument input module comprising:
a keyboard comprising a plurality of keys;
a sensor for sensing a pressure applied to a key of the plurality of keys, and generating an electrical current representative of the pressure; and
a processing circuit for processing the current into the first input signal.

16. The music device of claim 11, wherein the first touch sensitive surface corresponds to one a plurality of strings of a string instrument, a plurality of keys of a woodwind instrument, a plurality of valves of brass instrument, and a plurality of keys of a keyboard instrument or is completely programmable to create an entirely new musical or tonal parameters control instrument or musical or tonal input output system.

17. The music device of claim 7, further comprising:
a receiving part formed in one of the body and the neck; and
an electronic or non-electronic logo connected to the receiving part, and comprising a connector for detachably connecting the electronic logo to the receiving part.

18. A music device for making music, comprising:
a body;
a first input part formed on the body, for generating a first signal based on a user input;
a music signal generator formed in the body, for generating a music signal based on the first signal;
a neck connected to the body;
a second input part for generating a second signal based on a user input, the second signal controlling the music signal generator, and the second input part comprising a plurality of first buttons which correspond to a range comprising at least one of a key, a note and a chord, and a plurality of second buttons which correspond to at least one of a note and a musical scale within the range; and
an output part for outputting the music signal.

19. A system for making music, comprising:
a device for generating a programming signal; and
a music device which is programmable by the programming signal, for making music, comprising:
a first input part for generating a first signal based on a user input;
a music signal generator for generating a music signal based on the first signal; and
a second input part for generating a second signal based on a user input, the second signal controlling the music signal generator, and the second input part comprising a plurality of first buttons which correspond to a range comprising at least one of a key, a note and a chord, and a plurality of second buttons which correspond to at least one of a note and a musical scale within the range.

20. The system of claim 19, further comprising:
a display device which displays a musical notation corresponding to at least one of the plurality of first buttons and the plurality of second buttons, or other parameters,
wherein the display device comprises a heads-up display device comprising a wired or wireless transceiver that is connected to the music device.

21. The system of claim 19, further comprising:
a foot pedal module, which is in communication with the music signal generator of the music device and comprises an input portion which receives a user input and controls the music signal generator with the second signal based on the user input.

22. A method of making music, comprising:
generating a first signal with a first input part based on a user input;
generating a music signal with a music signal generator based on the first signal; and
generating a second signal with a second input part based on a user input, the second signal controlling the music signal generator, and the second input part comprising a plurality of first buttons which correspond to a range comprising at least one of a key, a note and a chord, and a plurality of second buttons which correspond to at least one of a note and a musical scale within the range.

23. A user-selectable primarily left or right-handed operable neck, comprising
a connecting part for connecting to the body of the music device of claim 5.

24. An user-selectable primarily left or right-handed operable input module, comprising:
a connecting part for connecting to the body of the music device of claim 5.

25. An electronic logo, comprising:
a connector and compatibility verifiable part, for connecting to the neck of the music device of claim 6.
